(19) United States
(12) Patent Application Publication
(10) Pub. No.: US 2017/0186116 A1
(43) Pub. Date: Jun. 29, 2017

(54) SYSTEM AND METHOD OF MONITORING, MEASURING AND REPORTING OF POST-CLOSING PROCESSES IN REAL ESTATE PURCHASE TRANSACTIONS AND DELIVERY OF TITLE INSURANCE POLICIES

(71) Applicant: 1TRACT LLC, Franklin, TN (US)

(72) Inventors: Charles Evan Poll, Kennesaw, GA (US); Christopher L. Cantrell, Brentwood, TN (US); Frank A. Coyle, Brentwood, TN (US); Robert L. Reich, Longwood, FL (US); Jonathan W. Walker, Antioch, TN (US); George E. Friend, Franklin, TN (US)

(21) Appl. No.: 15/286,141

(22) Filed: Oct. 5, 2016

Related U.S. Application Data
(60) Provisional application No. 62/237,370, filed on Oct. 5, 2015.

(51) Int. Cl. G06Q 50/16; G06Q 40/08

(52) U.S. Cl. CPC G06Q 50/167; G06Q 40/08

(57) ABSTRACT

A web browser-based information management system that helps ensure compliance with the Dodd-Frank Act, CFPB regulations and land title industry best practices by systematically monitoring, measuring and reporting the entire post-closing process related to real estate purchase transactions involving the issuance of title insurance and automating the delivery of title insurance policies to insured purchasers of real estate, their title insurance agency, title insurance underwriter and mortgagee.

### CROSS-REFERENCE TO RELATED APPLICATIONS

This application claims priority to U.S. Provisional Application No. 62/237,370 filed Oct. 5, 2015.

### FIELD OF THE DISCLOSURE

Various embodiments of the present disclosure concern the real estate industry, specifically land title, title insurance and mortgage loans and, more specifically systems, methods and web browser-based processes for monitoring, measuring and reporting of post-closing processes in real estate purchase and sale transactions and review, approval and delivery of title insurance policies to insured purchasers of real estate, their title insurance agency, title insurance underwriter and mortgagee.

### BACKGROUND

### Overview of the Land Title Market and Mortgage Crisis

The mortgage market is the single largest market for consumer financial products and services in the United States, with approximately $10.3 trillion in loans outstanding. During the last decade, the market went through an unprecedented cycle of expansion and contraction that was fueled in part by the securitization of mortgages and creation of increasingly sophisticated derivative products designed to mitigate accompanying risks. So many other parts of the American financial system were drawn into mortgage-related activities that when the bubble collapsed in 2008, it sparked the most severe recession in the United States since the Great Depression. The expansion in this market is commonly attributed to both particular economic conditions and by changes within the industry. Interest rates dropped significantly—by more than 20 percent—from 2000 through 2003. Housing prices increased dramatically—about 152 percent—between 1997 and 2006. Driven by the decrease in interest rates and the increase in housing prices, the volume of refinances increased from about 2.5 million loans in 2000 to more than 15 million in 2003.

At the same time, advances in the securitization of mortgages attracted increasing involvement from financial institutions that were not directly involved in the extension of credit to consumers and from investors worldwide. Securitization of mortgages allows originating lenders to sell off their loans (and reinvest the funds earned in making new ones) to investors who want an income stream over time. Securitization had been pioneered by what are now called government-sponsored enterprises (“GSEs”), such as the Federal National Mortgage Association (“Fannie Mae”) and the Federal Home Loan Mortgage Corporation (“Freddie Mac”). But by the early 2000s, large numbers of private financial institutions were deeply involved in creating increasingly sophisticated investment mortgage-related vehicles through securities and derivative products.

Growth in the mortgage loan market was particularly pronounced in what are known as “subprime” and “Alt-A” products. Subprime products were sold both to borrowers with poor or no credit history, as well as to borrowers with good credit. The Alt-A category of loans permitted borrowers to provide little or no documentation of income or other repayment ability. Because these loans involved additional risk, they were typically more expensive to borrowers than so-called “prime” mortgages, though many offered low introductory rates. In 2003, subprime and Alt-A origination volume was about $400 billion. In 2006, it had reached $830 billion.

So long as housing prices were continuing to increase, it was relatively easy for borrowers to refinance their loans to avoid interest rate resets and other adjustments. However, housing prices began to decline as early as 2005, slowing the growth in refinances. At the same time, as the economy worsened the rates of serious delinquency (90 or more days past due or in foreclosure) for these subprime and Alt-A products began a steep increase from approximately 10 percent in 2006, to 20 percent in 2007, to over 40 percent in 2010.

The impact of this level of delinquencies on the private investors who purchased these loans from the mortgage originators was severe. Private securitizations of subprime loans peaked at $465 billion in 2005, but were virtually eliminated in 2008. Private securitizations of Alt-A loans followed a similar trajectory. This effect was even felt by Fannie Mae and Freddie Mac, which were large purchasers of these securitizations, and it resulted in the Federal government in late 2008 placing the GSEs into conservatorship in order to support the collapsing mortgage market.

Four years later, the United States continued to grapple with the fallout. Home prices were down 35 percent from peak to trough on a national basis, and it was not clear whether the national market had reached bottom. The fall in housing prices was estimated to have resulted in about $7 trillion in household wealth losses. Moreover, mortgage markets continued to rely on extraordinary U.S. government support. In addition, distressed homeownership and foreclosure rates remained at unprecedented levels. Approximately 5.8 million homeowners were somewhere between 30 days late on their mortgage and in the foreclosure process as of April 2012. Finally, the U.S. continued to face a stubbornly high unemployment rate, which was at 8.2 percent at the end of May 2012.

While there remained debate about which market issues definitively sparked this crisis, there were several mortgage origination issues that pervaded the mortgage lending system prior to the crisis and are generally accepted as having contributed to its collapse. First, the market experienced a steady deterioration of credit standards in mortgage lending, particularly evidenced by the growth of subprime and Alt-A loans, which consumers were often unable or unwilling to repay. Second, the mortgage market saw a proliferation of more complex mortgage products with terms that were often difficult for consumers to understand. These products included most notably 2/28 and 3/27 Hybrid Adjustable Rate Mortgages (“ARM”) and Option ARM products. These products often were marketed to subprime and Alt-A customers. The appetite on the part of mortgage investors for such products often created inappropriate incentives for mortgage originators to originate these more expensive and profitable mortgage products. Third, responsibility for the regulation of consumer financial protection laws was spread across seven regulators including the U.S. Department of Housing and Urban Development (“HUD”), the Office of Thrift Supervision, the Federal Trade Commission (“FTC”), the Federal Deposit Insurance Corporation (“FDIC”), the Office of the Comptroller of the Currency, and the National Credit Union Administration. Such a spread in responsibility may have hampered the government's ability to coordinate regulatory monitoring and response to such issues.

In the wake of this financial crisis, Congress passed the Dodd-Frank Wall Street Reform and Consumer Protection Act (Pub. L. 111-203, H.R. 4173, Jul. 21, 2010) (commonly referred to as, “Dodd-Frank”) to address many of these concerns. In the Dodd-Frank Act, Congress created the Consumer Financial Protection Bureau (“CFPB”) and consolidated the rule making authority for many consumer financial protection statutes, including the two primary Federal consumer protection statutes governing mortgage origination, the Truth in Lending Act of 1968 (“TILA”) and the Real Estate Settlement Procedures Act (Pub. L. 93-533, Dec. 22, 1974) (“RESPA”), in the CFPB. Congress also provided the CFPB with supervision authority for certain consumer financial protection statutes over certain entities, including insured depository institutions with total assets over $10 billion and their affiliates, and certain other non-depository entities.

At the same time, Congress significantly amended the statutory requirements governing mortgage practices with the intent to restrict the practices that contributed to the crisis. For example, in response to concerns that some lenders made loans to consumers without sufficiently determining their ability to repay, section 1411 of the Dodd-Frank Act amended the TILA to require that creditors make a reasonable and good faith determination, based on verified and documented information, that the consumer will have a reasonable ability to repay the loan. Sections 1032(f), 1098, and 1100A of the Dodd-Frank Act address concerns that Federal mortgage disclosures did not adequately explain to consumers the terms of their loans (particularly complex adjustable rate or optional payment loans) by requiring new disclosure forms that will improve consumer understanding of mortgage transactions (which is the subject of this proposal). In addition, the Dodd-Frank Act established other new standards concerning a wide range of mortgage lending practices, including compensation for mortgage originators and mortgage servicing. Other provisions of Dodd-Frank and resulting regulatory provisions issued by the CFPB, as discussed below, relate to title insurance companies, settlement agents, mortgage lenders and other parties involved in the post-closing processes of real estate purchase and sale, or re-finance, transactions.

Even with the economic downturn, approximately $1.28 trillion in mortgage loans were originated in 2011 after Dodd-Frank was enacted. In exchange for a mortgage loan, borrowers promise to make regular mortgage payments and provide their home or real property as collateral. The overwhelming majority of homebuyers use mortgage loans to pay for at least some of their property. In 2011, for instance, 93 percent of all new home purchases were financed with a mortgage loan.

Borrowers may take out mortgage loans in order to purchase a new home, to refinance an existing mortgage, or to access home equity. Purchase loans and refinances produced 6.3 million new mortgage loan originations in 2011 alone. The proportion of loans that are for purchases as opposed to refinances varies with the interest rate environment. In 2011, 65 percent of the market was refinance transactions and 35 percent was purchase loans, by volume. Historically the distribution has been more even. In 2000, refinances accounted for 44 percent of the market while purchase loans comprised 56 percent, and in 2005 the two products were split evenly.

Using a home equity loan, a homeowner can use their equity as collateral in exchange for a loan. The loan proceeds can be used, for example, to pay for home improvements or to pay off other debts. These home equity loans resulted in an additional 1.3 million mortgage loan originations in 2011.

### The Mortgage Origination Process

Borrowers must go through a mortgage origination process to take out a mortgage loan. During this process, borrowers have two significant factors to consider: the costs that they pay to close the loan, and the costs over the life of the loan. Both factors can vary tremendously, making the home purchase especially complex. Furthermore, there are many participants involved in a mortgage origination. In addition to the lender and the borrower, a single transaction may involve a seller, mortgage broker, multiple real estate agents, settlement agent, appraiser, multiple insurance providers, and local government clerks and tax offices. These participants typically charge fees or commissions for the services they provide. Borrowers learn about the loan costs and the sources of those costs through a variety of sources, including disclosures provided throughout the mortgage origination process.

### Closing Costs

Closing costs are the costs of completing a mortgage transaction, including origination fees, appraisal fees, title insurance premiums, taxes, and homeowner's insurance. The borrower may pay an application or origination fee. Lenders also generally require an appraisal as part of the origination process in order to determine the value of the home. The appraisal helps the lender determine whether the home is valuable enough to act as collateral for the mortgage loan. The borrower is generally responsible for the appraisal fee, which may be paid at or before closing. Finally, lenders typically require borrowers to take out various insurance policies. Insurance protects the lender's collateral interest in the property. Homeowner's insurance protects against the risk that the home is damaged or destroyed, while title insurance protects the lender against the risk of claims against the borrower's legal right to the property. In addition, the borrower may be required to take out mortgage insurance which protects the lender in the event of default.

### Title Insurance Policy Production and Claim Response—A Fiduciary Intermediary

To complete a purchase or refinance of real estate, an exchange must take place. Value (or monies for the purchase or to pay off prior obligations) must be provided in exchange for transfer of the ownership interest held by the prior owner. In addition, the prior owner may make certain covenants and warranties (i.e., promises) and exclusions (i.e., disclaimers or reservations) to the purchaser as to the integrity and extent of ownership.

If a real estate purchase were to be made in exchange for cash where the property had no liens or other financial obligations to be paid, the exchange theoretically might take place with the seller and buyer at the jurisdiction of public record simultaneously, with the seller holding on to the cash of the purchaser as the seller and buyer hold the conveyance instrument as it is to be given to the public record. Neither the seller nor the buyer would relinquish possession of the title to the property or cash, respectively as the case may be, until the other party had fulfilled their obligations, preventing any intervening liens or other adverse claims against the property and, subsequently, the purchaser.

The title insurance, closing and escrow process attempts to make even the most complex transaction fit this ideal model where nothing is released to any party of the transaction until all obligations of all parties have been fulfilled.

The title agent acts as an independent fiduciary and may retain monies, conveyance instruments, loan documents, and down payments, “in escrow” until the closing. The title agent also insures that the items necessary to meet all obligations are brought to closing, at which time all obligations to all parties may be met as overseen by the independent agent.

If all obligations cannot be met, the title agent, as fiduciary, will release to the respective parties all items held by the agent “in escrow” and cancel the transaction.

To evaluate and report on the obligations which each party must fulfill, the title agent must research various public records, after which the agent produces a “commitment” to insure transfer of title of ownership with respect to the subject real estate.

The parties to the transaction (e.g., buyer, seller, lender, etc.) must complete all requirements listed and agree to be subject to the exceptions listed in the commitment. Once all requirements have been met, the insurer then follows through with its commitment to issue the purchaser's/mortgagee's title insurance policy.

If an adverse claim or challenge is made to the lien position, or ownership of an insured party a claim is made (if not specifically excluded in the policy), the title insurer either will resolve the issue to restore the insured status, refund the loan amount under the lender's title insurance policy, or refund the purchase price under the owner's title insurance policy to the insured.

Policies are generally issued either “at the table”—meaning that the title policy is delivered at the time the real estate transaction is closed, even if not all title requirements have been satisfied at that time—or upon satisfaction of all title requirements some period of time after closing, typically 30-45 days post-closing. With either of these two conventional methods, problematic issues remain. If all the title requirements are not satisfied at the time the transaction is closed, delivery of the title at the closing will be inappropriate. If the title is delivered after satisfaction of all the requirements, which is typically 30 to 45 days post-closing, it may not satisfy ALTA Best Practices, which require that title be issued and delivered within thirty days of settlement or after terms and conditions of title commitment are satisfied.

The attached workflow, as shown on FIG. 1, gives an overview of the variance between the two conventional methods.

Step 1—The transaction closing (i.e., signing of real estate transaction documents and receipt of all monies) occurs.

Step 2—If the agent is issuing “policies at the table,” the title insurance policy is issued on the assumption that the agent is now responsible for follow through on all tasks necessary to satisfy all pending title requirements.

Step 3—Regardless whether the title policy has been issued after closing, closing documents are submitted for public recording with the register's office in the county where the transferred real estate is located and demand for release is submitted with payment to holders of prior liens against the transferred property.

Step 4—Documents may be damaged or lost in transit, and/or may be rejected by the county register's office, so the title agent is obliged to monitor the public records to ensure proper recordation, including the order in which new liens against the transferred real property are recorded.

Step 5—When “all documents” are properly recorded, the title agent issues its title insurance policy, if not previously issued. Note, there is wide variance regarding the definition of “all documents,” with some agents issuing the title insurance policy at the recordation of the new conveyance and lien instruments, while others issuing the title insurance policy upon completion of the recordation of all requirement documentation.

Step 6—This conventional methodology to the present disclosure left title insurance underwriters with limited awareness of the overall soundness of each agent and the underlying risks of work in process, or policies issued with title requirements still pending, that had gone unfulfilled until an insured title insurance policy holder made a claim against the insurance policy.

Step 7—If no problems or claims arose, this is the end of the real estate transaction and title insurance policy delivery and fulfillment.

Step 8—If documents are rejected for recordation by the county register's office, the submitting party would receive a rejection notice and, if possible, resubmit the documentation for future recording, often requiring a closing document to be re-executed.

Step 9—If a claim is issued, the title insurer may resolve the claim by various methods, including correcting the original documentation, thereby restoring the ownership or lienholder interest as insured, or proceed to Step 10 below as an alternative.

Step 10—The insurer may pay or deny the insured policy holder's claim (e.g., if the condition is excluded from coverage).

### Closing

After being accepted for a mortgage loan, completing any closing requirements, and receiving necessary disclosures, the borrower can close on the loan. Multiple parties participate at closing, including the seller, borrower, lending bank or mortgage company (“mortgagee”) and the settlement agent, which often is the title company either owned by or independently contracted with a title insurance underwriter. Often, title requirements will not have been satisfied by the closing or settlement of the real estate transaction. For instance, a title requirement typically will be pay-off of the seller's mortgage and the release of mortgage lien/deed of trust by the seller's lender/mortgage company. This requirement almost never can be satisfied as of closing.

The settlement agent ensures that all closing requirements are met, and that all fees are collected. Again, however, at closing it often is true that not all title requirements have been satisfied, which means that the title company may not issue the title insurance policy until after closing, typically 30-60 days after closing. The settlement agent also completes all of the closing documents. The settlement agent makes sure that the borrower signs these closing documents, including a promissory note and the security instrument. This promissory note is evidence of the loan debt, and documents the borrower's promise to pay back the loan. It states the terms of the loan, including the interest rate and length. The security instrument, in the form of a mortgage, provides the home as collateral for the loan. A deed of trust is similar to a mortgage, except that a trustee is named to hold title to the property as security for the loan. The borrower receives title to the property after the loan is paid in full. Both a mortgage and deed of trust allow the lender to foreclose and sell the home if the borrower does not repay the loan.

In the case of a purchase loan, the funds to purchase the home and pay closing costs are distributed at closing or shortly thereafter. In the case of a refinance loan, the funds from the new loan are used to pay off the old loan, with any additional amount going to the borrower or to pay off other debts. Refinance loans also have closing costs, which may be paid by the borrower at closing or, in some cases, rolled into the loan amount. In home-equity loans, the borrower's funds and the closing costs are provided upon closing. A settlement agent makes sure that all amounts are given to the appropriate parties. After the closing, the settlement agent records the purchase money mortgage/deed at the local government registry.

### State Statutory Deadlines for Filing Lien Releases after Pay-Off

Once a mortgage or deed of trust is paid off at settlement, the holder of the mortgage (i.e., mortgagee) is required under state law to satisfy the mortgage or deed of trust of record to show that the mortgage or deed of trust is no longer a lien on the property. The general rule is that the satisfaction must be in proper written format and recorded to provide notice of the satisfaction. The required timing for a paid-off lender to record its release of lien varies by state but typically is either 30, 45, 60 or 90 days after pay off. For instance, California has a 30 day statutory deadline for lenders to record their satisfactions of mortgage/deed of trust after pay-off, Tennessee has a 45 day statutory deadline and Florida has a 60 day statutory deadline.

If the lender fails to record a satisfaction within set state statutory time limits, the lender may be responsible for fines and penalties, including attorney's fees, set by state statute for failure to timely cancel the lien. Depending on each state's customs and practices, a satisfaction may be called a satisfaction, cancellation or re-conveyance. Some states still recognize marginal satisfaction where the holder of the mortgage physically goes to the recording office and enters a satisfaction on the face of the recorded mortgage, which is attested by the clerk. For present purposes, we refer to all of state-required film lien release filings as satisfactions.

### Regulation X

The financial crisis exposed pervasive consumer protection problems across major segments of the mortgage servicing industry. As millions of borrowers fell behind on their loans, many servicers failed to provide the level of service necessary to serve the needs of those borrowers. Many servicers simply had not made the investments in resources and infrastructure necessary to service large numbers of delinquent loans. Existing weaknesses in servicer practices, including inadequate record keeping and document management and lack of oversight of service providers, made it harder to sort out borrower problems to achieve optimal results. In addition, many servicers took short cuts that made things even worse. As one review of fourteen major servicers found, companies “emphasize[d] speed and cost efficiency over quality and accuracy” in their foreclosure processes. See http://www.occ.gov/news-issuances/news-releases/2011/nr-occ-2011-47a.pdf.

The Dodd-Frank Act adopted several new servicing protections. It gave the newly-established CFPB the authority to promulgate regulations to implement those new servicing protections. These changes significantly improved disclosures to make it easier for consumers to monitor their mortgage loans and servicers' activities. The changes also address critical servicer practices, including error resolution, prompt crediting of payments, and “forceplacing” insurance where borrowers have allowed their hazard insurance policies to lapse.

The Dodd-Frank Act also gave the CFPB discretionary authority to develop additional servicing rules. The CFPB has used this authority to adopt requirements relating to reasonable information management policies and procedures, early intervention with delinquent borrowers, continuity of contact, and procedures for evaluating and responding to loss mitigation applications when the servicer makes loss mitigation options available in the ordinary course of business.

These proposals address fundamental problems that underlie many consumer complaints and recent regulatory and enforcement actions. The CFPB asserts that these changes reduce avoidable foreclosures and improve general customer service. The proposals cover nine major topics, as summarized below.

The CFPB's proposal under RESPA Regulation X is split into two parts because Congress imposed some requirements under TILA and some under RESPA. Proposed rules in 2012 were published to amend Regulation X, which implements RESPA, to implement section 1463 of the Dodd-Frank Act concerning error resolution and force-placed insurance and to impose additional requirements concerning reasonable information management policies and procedures, early intervention with delinquent borrowers, continuity of contact, and procedures for evaluating and responding to loss mitigation applications.

### Summary of Regulation X

On Jan. 17, 2013, the CFPB issued a final rule to amend Regulation X (78 Fed. Reg. 10695) (Feb. 14, 2013). The final rule implemented certain provisions of Title XIV of the Dodd-Frank Act and included substantive and technical changes to the existing regulations. Substantive changes included modifying the servicing transfer notice requirements and implementing new procedures and notice requirements related to borrowers' error resolution requests and information requests. The amendments also included new provisions related to escrow payments, force-placed insurance, general servicing policies, procedures, and requirements, early intervention, continuity of contact, and loss mitigation. The amendments were effective as of Jan. 10, 2014.

On Jul. 10, 2013, Sep. 13, 2013, and Oct. 22, 2014, the CFPB issued final rules to further amend Regulation X (78 Fed. Reg. 44685) (Jul. 24, 2013), (78 Fed. Reg. 60381) (Oct. 1, 2013), and (79 Fed. Reg. 65299) (Nov. 3, 2014). The final rules included substantive and technical changes to the existing regulations, including revisions to provisions on the relation to state law of Regulation X's servicing provisions, to the loss mitigation procedure requirements, and to the requirements relating to notices of error and information requests. On Oct. 15, 2013, the CFPB issued an interim final rule to further amend Regulation X (78 Fed. Reg. 62993) (Oct. 23, 2013) to exempt servicers from the early intervention requirements in certain circumstances. The Regulation X amendments were effective as of Jan. 10, 2014.

### Error Resolution Procedures

### 12 C.F.R. §1024.35

Under Regulation X, servicers must comply with error resolution procedures that are triggered when a borrower (or agent of the borrower) submits an error notice to the servicer. The requirements set forth in 12 C.F.R. §1024.35 apply to any mortgage loan, as that term is defined in 12 C.F.R. §1024.31. A “notice of error” includes failure to transfer accurate and timely information relating to servicing to a transferee servicer and any other error relating to the servicing of a borrower's mortgage loan. A full description of what constitutes a “notice of error” is provided below.

The CFPB issued an advisory opinion clarifying that, because borrowers initiate the error resolution process, a servicer's communications with a borrower regarding an error notice are not subject to the “cease communication” provision of the Fair Debt Collection Practices Act (“FDCPA”) unless the borrower specifically withdraws the request for action regarding the error.

### Qualified Written Request (“QWR”)

### 12 C.F.R. §1024.21(e)

If the borrower believes there is an error in the mortgage account, he or she can make a “qualified written request” to the loan servicer. The request must be in writing, identify the borrower by name and account, and include a statement of reasons why the borrower believes the account is in error. The request should include the words “qualified written request”. A qualified written request means a written correspondence (other than notice on a payment coupon or other payment medium supplied by the servicer) that includes, or otherwise enables the servicer to identify, the name and account of the borrower, and includes a statement of the reasons that the borrower believes the account is in error, if applicable, or that provides sufficient detail to the servicer regarding information relating to the servicing of the loan sought by the borrower.

The servicer must acknowledge receipt of the request within five (5) business days. The servicer then has thirty (30) business days (from the request) to take action on the request. The servicer has to either provide a written notification that the error has been corrected, or provide a written explanation as to why the servicer believes the account is correct. Either way, the servicer has to provide the name and telephone number of a person with whom the borrower can discuss the matter. The servicer cannot provide information to any credit agency regarding any overdue payment during the 60-day period.

If the servicer fails to comply with the “qualified written request”, the borrower is entitled to actual damages, up to $2,000 of additional damages if there is a pattern of noncompliance, costs and attorney's fees. See 12 U.S.C. §2605(f).

As indicated above under “State Statutory Deadlines,” once a mortgage or deed of trust is paid off at settlement, the holder of the mortgage (i.e., mortgagee) is required under state law to satisfy the mortgage or deed of trust of record to show that the mortgage or deed of trust is no longer a lien on the property. A lender's failure to fulfill this state law requirement may be addressed by, and subject the lender to, a qualified written request from the borrower or agent of the borrower.

### Notice of Error (“NOE”)

### 12 C.F.R. §1024.35(a)

A notice of error must be in writing and identify the borrower's name, information that allows the servicer to identify the borrower's account, and the alleged error. A qualified written request that asserts an error relating to the servicing of a mortgage loan is an error notice, and the servicer must comply with all of the error notice requirements with respect to such qualified written request.

CFPB commentary clarifies that a servicer should not rely solely on the borrower's description of a submission to determine whether it is an error notice, an information request, or both. For example, a borrower may submit a letter titled “Notice of Error” that indicates that the borrower wants to receive the information set forth in an annual escrow account statement and asserts an error for the servicer's failure to provide that statement. Such a letter could be both an error notice and an information request, and the servicer must evaluate whether the letter fulfills the substantive requirements of an error notice, information request, or both.

### Borrower's Representative

Pursuant to CFPB commentary to these regulations, a notice of error is deemed submitted by a borrower if the notice of error is submitted by an agent of the borrower. A servicer may undertake reasonable procedures to determine if a person that claims to be an agent of a borrower has authority from the borrower to act on the borrower's behalf, for example, by requiring that a person that claims to be an agent of the borrower provide documentation from the borrower stating that the purported agent is acting on the borrower's behalf. Upon receipt of such documentation, the servicer shall treat the notice of error as having been submitted by the borrower.

### Scope of Error Resolution

### 12 C.F.R. §1024.35(b)

The error resolution procedures apply to the following alleged errors:
Failure to accept a payment that complies with the servicer's written requirements.
Failure to apply an accepted payment to principal, interest, escrow, or other charges as required by the mortgage loan and applicable law.
Failure to credit a payment to the borrower's account as of the date the servicer received it, as required by 12 C.F.R. §1026.36(c)(1).
Failure to pay taxes, insurance premiums, or other charges by the due date, as required by 12 C.F.R. §1024.34(a).
Failure to refund an escrow account balance within 20 days (excluding legal public holidays, Saturdays, and Sundays) after the borrower pays the mortgage loan in full, as required by 12 C.F.R. §1024.34(b).
Imposition of a fee or charge without a reasonable basis to do so.
Failure to provide an accurate payoff balance amount upon the borrower's request, as required by 12 C.F.R. §1026.36(c)(3).
Failure to provide accurate information to a borrower regarding loss mitigation options and foreclosure, as required by 12 C.F.R. §1024.39.
Failure to transfer accurate and timely information relating to servicing to a transferee servicer (emphasis added).
Making the first notice or filing for a judicial or non-judicial foreclosure process before the time periods allowed by 12 C.F.R. §1024.41(f) and (j).
Moving for foreclosure judgment or order of sale or conducting a foreclosure sale in violation of 12 C.F.R. §1024.41(g) or (j).
Any other error relating to the servicing of a borrower's mortgage loan (emphasis added).

CFPB commentary gives examples of errors not covered by 12 C.F.R. §1024.35(b), such as errors relating to: (i) the origination of a mortgage loan; (ii) the underwriting of a mortgage loan; (iii) a subsequent sale or securitization of a mortgage loan; and (iv) a determination to sell, assign, or transfer the servicing of a mortgage loan (unless it concerns the failure to transfer accurate and timely information relating to the servicing of the borrower's mortgage loan account to a transferee servicer).

As indicated above under “State Statutory Deadlines,” once a mortgage or deed of trust is paid off at settlement, the holder of the mortgage (i.e., mortgagee) is required under state law to satisfy the mortgage or deed of trust of record to show that the mortgage or deed of trust is no longer a lien on the property. A lender's failure to fulfill this state law requirement may be addressed by, and subject the lender to, a notice of error from the borrower or agent of the borrower.

### Contact Information

### 12 C.F.R. §1024.35(c)

If the servicer establishes an address to which borrowers must send error notices, the servicer must provide written notice of the address to the borrower with specified content. CFPB commentary states that the servicer also must include this address on the following communications: (i) any periodic statement or coupon book required under 12 C.F.R. §1026.41; (ii) any website the servicer maintains in connection with the servicing of the loan; and (iii) any notice required pursuant to 12 C.F.R. §1024.39 (early intervention) or 12 C.F.R. §1024.41 (loss mitigation) that includes contact information for assistance. The servicer must use the same address for receiving information requests under 12 C.F.R. §1024.36(b) and provide written notice to the borrower before changing the address to which the borrower must send error notices.

### Acknowledgement of Receipt

### 12 C.F.R. §1024.35(d)

The servicer generally must provide a written acknowledgment to the borrower within five (5) days (excluding legal public holidays, Saturdays, and Sundays) after receiving the error notice.

### Response to an Error Notice

### 12 C.F.R. §1024.35(e)

A servicer generally has thirty (30) days (excluding legal public holidays, Saturdays, and Sundays) from receipt of the error notice to investigate and respond to the notice, except that a servicer may extend this period by an additional fifteen (15) days (excluding legal public holidays, Saturdays, and Sundays) if, prior to the expiration of the original 30-day period, it notifies the borrower in writing of the extension and the reasons for it. A servicer must respond within seven days (excluding legal public holidays, Saturdays, and Sundays) if the alleged error is a failure to provide an accurate payoff balance amount, and a servicer must respond by the earlier of thirty (30) days (excluding legal public holidays, Saturdays, and Sundays) or the date of a foreclosure sale if the error involves either (i) making the first notice or filing for a judicial or non-judicial foreclosure process before the time periods allowed by 12 C.F.R. §1024.41(f) or (j), or (ii) moving for foreclosure judgment or order of sale or conducting a foreclosure sale in violation of 12 C.F.R. §1024.41(g) or (j).

In response to the notice of error, the servicer must either correct the error or conduct a reasonable investigation and determine that no error occurred. The servicer also must send a written response to the borrower that accomplishes one of the following:
If the servicer corrects the alleged error. The servicer must advise the borrower of the correction and when the correction took effect, and provide contact information, including phone number, for further assistance;
If the servicer determines that it committed an error or errors different than or in addition to those identified by the borrower. The servicer must correct the error and advise the borrower of the correction and when the correction took effect, and provide contact information, including phone number, for further assistance; or
If the servicer determines after a reasonable investigation that no error occurred. The servicer must state that it determined that no error occurred, the reasons for its determination, and the borrower's right to request documents relied upon by the servicer in reaching its determination and how the borrower can make such a request, and provide contact information, including phone number, for further assistance. If the borrower requests those documents, the servicer generally must provide them within 15 days (excluding legal public holidays, Saturdays, and Sundays) at no cost to the borrower. The servicer need not provide documents that constitute confidential, proprietary, or privileged information.

As a part of its investigation of the asserted error, the servicer may request supporting documentation from the borrower, but the servicer must conduct a reasonable investigation even if the borrower does not provide supporting documentation.

### Early Correction of Error Asserted Before Foreclosure Sale

### 12 C.F.R. §1024.35(f)

A servicer is not required to provide the five-day acknowledgement notice (12 C.F.R. §1024.35(d)) or the response notice (12 C.F.R. §1024.35(e)) if either:
The servicer corrects the asserted errors and notifies the borrower of the correction within five days (excluding legal public holidays, Saturdays, and Sundays) after receiving the error notice; or
The servicer receives the error notice seven or fewer days before a foreclosure sale and the asserted error concerns the timing of the foreclosure process under Section 1024.35(b)(9) or (10). In this instance, the servicer shall make a good faith attempt to respond to the borrower, either orally or in writing, and either correct the error or state the reason the servicer has determined that no error occurred.

### Requirements Not Applicable

### 12 C.F.R. §1024.35(g)

A servicer does not need to provide the five-day acknowledgement notice (12 C.F.R. §1024.35(d)), provide the response notice (12 C.F.R. §1024.35(e)), or refrain from providing adverse information to credit reporting agencies for 60 days (12 C.F.R. §1024.35(i)), if the servicer reasonably determines any of the following apply:
Duplicative notice of error. The asserted error is substantially the same as a previously-asserted error for which the servicer complied with the obligation to respond, unless the borrower provides new and material information to support the asserted error. New and material information is information that is reasonably likely to change the servicer's prior determination about the error;
Overbroad notice of error. The error notice is overbroad if the servicer cannot reasonably determine the specific alleged error. CFPB commentary provides examples of overbroad notices, including those that assert errors regarding substantially all aspects of the mortgage loan (including origination, servicing, and foreclosure), notices that resemble legal pleadings and demand a response to each numbered paragraph, or notices that are not reasonably understandable or contain voluminous tangential information such that a servicer cannot reasonably identify from the notice any error that requires a response. Note that if a servicer concludes an error notice as submitted is overbroad, the servicer must still provide a five-day acknowledgment notice and a subsequent response to the extent the servicer can identify an appropriate error notice within the submission; or
Untimely notice of error. The error notice is sent more than one year after either the mortgage loan balance was paid in full or the servicer transferred the mortgage loan to another servicer.

If a servicer determines that any of these three exceptions apply, it must provide written notice to the borrower within five days (excluding legal public holidays, Saturdays, and Sundays) after making that determination, including the basis relied upon.

### Payment Requirements Prohibited

### 12 C.F.R. §1024.35(h)

A servicer may not charge a fee or require a borrower to make any payments as a condition to responding to an error notice.

### Effect on Servicer Remedies

### 12 C.F.R. §1024.35(i)

In the 60-day period after receiving an error notice, a servicer may not furnish adverse information to any consumer reporting agency regarding any payment that is the subject of the error notice.

### Requests for Information (“RFI”)

### 12 C.F.R. §1024.36

Servicers must follow certain procedures in response to a borrower's written request for information with respect to the borrower's mortgage loan. The request must include the borrower's name, information that allows the servicer to identify the borrower's account, and the requested information related to the borrower's mortgage loan. The request can be from the borrower or the borrower's agent; a servicer may undertake reasonable procedures to determine if an alleged agent has authority from the borrower to act as the borrower's agent. A qualified written request that requests information relating to the servicing of a mortgage loan is an information request, and the servicer must comply with all of the information request requirements with respect to such a qualified written request.

The requirements set forth in 12 C.F.R. §1024.36 apply to any mortgage loan, as that term is defined in 12 C.F.R. §1024.31.

As indicated above under “State Statutory Deadlines,” once a mortgage or deed of trust is paid off at settlement, the holder of the mortgage (i.e., mortgagee) is required under state law to satisfy the mortgage or deed of trust of record to show that the mortgage or deed of trust is no longer a lien on the property. A lender's failure to fulfill this state law requirement may be addressed by, and subject the lender to, a request for information from the borrower or agent of the borrower.

### Contact Information

### 12 C.F.R. §1024.36(b)

If the servicer establishes an address to which borrowers must send information requests, the servicer must provide written notice of the address to the borrower with specified information. The servicer also must use the same address for receiving error notices under 12 C.F.R. §1024.35(b), post the address on any website maintained by the servicer if the website lists any contact address for the servicer, and provide notice to the borrower before changing the address to which the borrower must send error notices.

### Acknowledgement of Receipt

### 12 C.F.R. §1024.36(c)

The servicer generally must provide a written acknowledgment to the borrower within five (5) days (excluding legal public holidays, Saturdays, and Sundays) after receiving the information request.

### Response to Information Request

### 12 C.F.R. §1024.36(d)

A servicer generally must respond in writing to an information request within thirty (30) days (excluding legal public holidays, Saturdays, and Sundays) of receipt, except that a servicer may extend this period by an additional fifteen (15) days (excluding legal public holidays, Saturdays, and Sundays) if, prior to the expiration of the original 30-day period, it notifies the borrower in writing of the extension and the reasons for it. A servicer must respond within ten (10) days (excluding legal public holidays, Saturdays, and Sundays) after receiving the request, if the borrower requested the identity or contact information for the owner or assignee of a mortgage loan.

The servicer must respond in writing by either:
Providing the requested information and contact information, including phone number, for further assistance; or
Conducting a reasonable search for the information and advising the borrower that the servicer has determined that the requested information is not available to it, the basis for the servicer's determination, and contact information, including phone number, for further assistance.

Information is not available if it is not in the servicer's control or possession, or the servicer cannot retrieve it in the ordinary course of business through reasonable efforts. CFPB commentary gives examples of when information is or is not available.

### Early Response

### 12 C.F.R. §1024.36(e)

The five-day receipt acknowledgement (12 C.F.R. §1024.36(c)) and the response (12 C.F.R. §1024.36(d)) requirements do not apply if the servicer provides the requested information and contact information, including phone number, for further assistance within five (5) days (excluding legal public holidays, Saturdays, and Sundays) after receiving the information request.

### Requirement Not Applicable

### 12 C.F.R. §1024.36(f)

The five-day receipt acknowledgement (12 C.F.R. §1024.36(c)) and the response notice (12 C.F.R. §1024.36(d)) requirements also do not apply if the servicer reasonably determines any of the following exceptions apply:
The information requested is substantially the same information that the borrower previously requested.
The information requested is confidential, proprietary, or privileged.
The information requested is not directly related to the borrower's mortgage loan account. CFPB commentary provides examples of irrelevant information, including information related to the servicing of mortgage loans other than the borrower's loan and investor instructions or requirements for servicers regarding the negotiation or approval of loss mitigation options.
The information request is overbroad or unduly burdensome. A request is overbroad if the borrower requests that the servicer provide an unreasonable volume of documents or information. A request is unduly burdensome if a diligent servicer could not respond within the time periods set forth in 12 C.F.R. §1024.46(d)(2) or would incur costs (or have to dedicate resources) that would be unreasonable in light of the circumstances. CFPB commentary provides examples of overbroad or unduly burdensome requests, such as requests that seek documents relating to substantially all aspects of mortgage origination, mortgage servicing, mortgage sale or securitization, and foreclosure, as well as requests that require servicers to provide information in a specific format or seek information that is not reasonably likely to assist the borrower. If an information request as submitted is overbroad or unduly burdensome, the servicer must still provide the five-day acknowledgment of receipt and subsequent response if the servicer can reasonably identify an appropriate information request within the submission.
The information request is sent more than one year after either the mortgage loan balance was paid in full or the servicer transferred the mortgage loan to another servicer.

If a servicer determines that any of these five exceptions apply, it must provide written notice to the borrower within five days (excluding legal public holidays, Saturdays, and Sundays) after making that determination, including the basis relied on.

### Payment Requirement Limitations

### 12 C.F.R. §1024.36(g)

A servicer generally may not charge a fee, or require a borrower to make any payment that may be owed on a borrower's account, as a condition of responding to an information request. A servicer may charge for providing a beneficiary notice under applicable State law, if such a fee is not otherwise prohibited by applicable law.

### General Servicing Policies, Procedures and Requirements

### 12 C.F.R. §1024.38

Servicers must maintain policies and procedures reasonably designed to achieve certain servicing-related objectives, and are subject to requirements regarding record retention and the ability to create servicing files.

These requirements apply to any mortgage loan, as that term is defined in 12 C.F.R. §1024.31, except that they do not apply to (i) small servicers, (ii) reverse mortgage transactions, as that term is defined in 12 C.F.R. §1024.31, or (iii) mortgage loans for which the servicer is a qualified lender. As noted above, an institution qualifies as a small servicer if it either (a) services, together with any affiliates, 5,000 or fewer mortgage loans, for all of which the institution (or an affiliate) is the creditor or assignee, or (b) is a Housing Finance Agency, as defined in 24 C.F.R. §266.5. Qualified lenders are those defined to be qualified lenders under the Farm Credit Act of 1971 and the Farm Credit Administration's accompanying regulations set forth at 12 C.F.R. §617.7000 et seq.

### Reasonable Policies and Procedures

### 12 C.F.R. §1024.38(a)

Servicers must maintain policies and procedures reasonably designed to meet the objectives identified in 12 C.F.R. §1024.38(b). Servicers may determine the specific policies and procedures they will adopt and the methods for implementing them in light of the size, nature, and scope of the servicer's operations, including, for example, the volume and aggregate unpaid principal balance of mortgage loans serviced, the credit quality (including the default risk) of the mortgage loans serviced, and the servicer's history of consumer complaints. “Procedures” refer to the servicer's actual practices for achieving the objective.

### Objectives

### 12 C.F.R. §1024.38(b)

Servicers are required to maintain policies and procedures that are reasonably designed to achieve the following objectives.

1. Accessing and Providing Timely and Accurate Information.

The servicer's policies and procedures must be reasonably designed to ensure that the servicer can:
(a) Provide accurate and timely disclosures to the borrower (emphasis added).
(b) Investigate, respond to, and make corrections in response to borrower's complaints. These policies and procedures must be reasonably designed to ensure that the servicer can promptly obtain information from service providers to facilitate investigation and correction of errors resulting from actions of service providers (emphasis added).
(c) Provide a borrower with accurate and timely information and documents in response to the borrower's request for information with respect to the borrower's mortgage loan (emphasis added).
(d) Provide owners and assignees of mortgage loans with accurate information and documents about all the mortgage loans that they own. This includes information about a servicer's evaluations of borrowers for loss mitigation options and a servicer's loss mitigation agreements with borrowers, including loan modifications. Such information includes, for example: (a) a loan modification's date, terms, and features; (b) the components of any capitalized arrears; (c) the amount of any servicer advances; and (d) any assumptions regarding the value of property used in evaluating any loss mitigation options.
(e) Submit documents or filings required for a foreclosure process, including documents or filings required by a court that reflect accurate and current information and that comply with applicable law.
(f) Upon notification of a borrower's death, promptly identify and facilitate communication with the borrower's successor in interest concerning the secured property.

2. Properly Evaluating Loss Mitigation Applications.

The servicer's policies and procedures must be reasonably designed to ensure that the servicer can:
(a) Provide accurate information regarding loss mitigation options available to the borrower from the owner or assignee of the borrower's loan.
(b) Identify specifically all loss mitigation options available to a borrower from the owner or assignee of the borrower's mortgage loan. This includes identifying, with respect to each owner or assignee all of the loss mitigation options the servicer may consider when evaluating a borrower, as well as the criteria the servicer should apply for each option. The policies and procedures should be reasonably designed to address how the servicer will apply any specific thresholds for eligibility for particular loss mitigation options established by an owner or assignee of a mortgage loan (e.g., if the owner requires that a particular option be limited to a certain percentage of loans, then the policies and procedures must be reasonably designed to determine in advance how the servicer will apply that threshold). The policies and procedures must be reasonably designed to ensure that such information is readily accessible to the servicer's loss mitigation personnel.
(c) Provide the loss mitigation personnel assigned to the borrower's mortgage loan with prompt access to all of the documents and information that the borrower submitted in connection with a loss mitigation option.
(d) Identify the documents and information a borrower must submit to complete a loss mitigation application, and facilitate compliance with the notice required pursuant to 12 C.F.R. §1024.41 (b)(2)(i)(B).
(e) In response to a complete loss mitigation application, properly evaluate the borrower for all eligible loss mitigation options pursuant to any requirements established by the owner or assignee of the mortgage loan, even if those requirements are otherwise beyond the requirements of 12 C.F.R. §1024.41. For example, an owner or assignee may require that the servicer review a loss mitigation application submitted less than 37 days before a foreclosure sale or re-evaluate a borrower who has demonstrated a material change in financial circumstances.

3. Facilitating Oversight of, and Compliance by, Service Providers.

The servicer's policies and procedures must be reasonably designed to ensure that the servicer can:
(a) Provide appropriate personnel with access to accurate and current documents and information concerning service provider's actions.
(b) Facilitate periodic reviews of service providers.
(c) Facilitate the sharing of accurate and current information regarding the status of any evaluation of a borrower's loss mitigation application and any foreclosure proceeding among appropriate servicer personnel, including the loss mitigation personnel assigned the borrower's mortgage loan, and appropriate service provider personnel, including service provider personnel responsible for handling foreclosure proceedings.

4. Facilitating Transfer of Information During Servicing Transfers.
(a) Transferor Servicer. The servicer's policies and procedures must be reasonably designed to ensure that when it transfers a mortgage loan to another servicer, it (i) timely and accurately transfers all information and documents in its possession and control related to a transferred mortgage loan to the transferee servicer, and (ii) transfers the information and documents in a form and manner that ensures their accuracy and that allows the transferee to comply with the terms of the mortgage loan and applicable law. For example, where data is transferred electronically, a transferor servicer must have policies and procedures reasonably designed to ensure that data can be properly and promptly boarded by a transferee servicer's electronic systems. The information that must be transferred includes information reflecting the current status of discussions with the borrower concerning loss mitigation options, any loss mitigation agreements entered into with the borrower, and analysis the servicer performed with respect to potential recovery from a non-performing mortgage loan.
(b) Transferee Servicer. The servicer's policies and procedures must be reasonably designed to ensure that when it receives a mortgage loan from another servicer, it can (i) identify necessary documents or information that may not have been transferred, and (ii) obtain such documentation or information from the transferor servicer. The servicer's policies and procedures also must be reasonably designed to address obtaining missing information regarding loss mitigation from the transferor servicer before attempting to obtain it from the borrower. For example, if a servicer receives information indicating that a borrower has made payments consistent with a trial or permanent loan modification but the servicer has not received information about the actual modification, the servicer must have policies and procedures reasonably designed to identify whether any such modification agreement exists and to obtain any such agreement from the transferor servicer.

5. Informing Borrowers of the Written Error Resolution and Information Request Procedures.
(a) The servicer must have policies and procedures reasonably designed to inform borrowers of the procedures for submitting written error notices under 12 C.F.R. §1024.35 and written information requests under 12 C.F.R. §1024.36. A servicer may comply with these requirements by informing borrowers of these procedures by notice (mailed or delivered electronically) or a website. For example, a servicer may comply with this provision by including a statement in the 12 C.F.R. §1026.41 periodic statement advising borrowers that they have certain rights under Federal law related to resolving errors and requesting information, that they may learn more about their rights by contacting the servicer, and directing borrowers to a website. A servicer's policies and procedures also must be reasonably designed to ensure that the servicer provides borrowers who are dissatisfied with the servicer's response to oral complaints or information requests with information about submitting a written error notice or written information request.

### Standard Requirements

### 12 C.F.R. §1024.38(c)

Servicers must retain certain records and maintain particular documents in a manner that facilitates compiling such documents and data into a servicing file.

### Record Retention

### 12 C.F.R. §1024.38(c)(1)

Servicers must retain records that document any actions the servicer took with respect to a borrower's mortgage loan account until one year after the loan is discharged or the servicer transfers servicing for the mortgage loan. Servicers may use any retention method that reproduces records accurately (such as computer programs) and that ensures that a servicer can access the records easily (such as a contractual right to access records another entity holds).

### Servicing File

### 12 C.F.R. §1024.38(c)(2)

Servicers must maintain the following documents and data in a manner that facilitates compiling such documents and data into a servicing file within five days: a schedule of all credits and debits to the account (including escrow accounts and suspense accounts), a copy of the security instrument establishing the lien securing the mortgage, any notes created by servicer personnel concerning communications with the borrower, a report of the data fields created by the servicer's electronic systems relating to the borrower's account (if applicable), and copies of any information or documents provided by the borrower in connection with error notices or loss mitigation.

For purposes of this section, a report of data fields relating to a borrower's account means a report listing the relevant data fields by name, populated with any specific data relating to the borrower's account. Examples of such data fields include fields used to identify the terms of the borrower's mortgage loan, the occurrence of automated or manual collection calls, the evaluation of borrower for a loss mitigation option, the owner or assignee of a mortgage loan, and any credit reporting history.

These requirements apply only to information created on or after Jan. 10, 2014.

### Live Contact

### 12 C.F.R. §1024.38(a)

Servicers must make good faith efforts to establish live contact with a borrower no later than the thirty-sixth day of delinquency. Promptly after establishing live contact, the servicer must inform the borrower of any loss mitigation options, if appropriate.

It is within the servicer's reasonable discretion to determine whether it is appropriate under the circumstances to inform a borrower of any loss mitigation options. Examples of a servicer making a reasonable determination include a servicer informing a borrower about loss mitigation options after the borrower notifies the servicer during live contact of a material adverse change in financial circumstances that is likely to cause a long-term delinquency for which loss mitigation options may be available, or a servicer not providing information about loss mitigation options to a borrower who has missed a January 1 payment and notified the servicer that the full late payment will be transmitted to the servicer by February 15.

### Written Notice

### 12 C.F.R. §1024.39(b)

Servicers must send a borrower a written notice within forty-five (45) days after the borrower becomes delinquent. The written notice must encourage the borrower to contact the servicer, provide the servicer's telephone number and address to access assigned loss mitigation personnel, describe examples of loss mitigation options that may be available (if applicable), provide loss mitigation application instructions or advise how to obtain more information about loss mitigation options such as contacting the servicer (if applicable), and list either the CFPB's or HUD's website to access a list of homeownership counselors or counseling organization and HUD's toll-free number to access homeownership counselors or counseling organizations.

A servicer is not required to provide the written notice under this section to a borrower more than once in any 180-day period.

### Conflicts with Other Law

### 12 C.F.R. §1024.39(c)

Servicers are not required to comply with the live contact and written notice requirements if doing so would violate applicable law. Thus, for example, a servicer does not need to communicate with borrowers in a way that would be inconsistent with bankruptcy law.

### Continuity of Contact

### 12 C.F.R. §1024.40

Servicers must maintain policies and procedures to facilitate continuity of contact between the borrower and the servicer.

These requirements apply to only those mortgage loans, as that term is defined in 12 C.F.R. §1024.31, that are secured by the borrower's principal residence. The requirements do not apply to (i) small servicers, (ii) reverse mortgage transactions, as that term is defined in 12 C.F.R. §1024.31, or (iii) mortgage loans for which the servicer is a qualified lender.

As noted above, an institution qualifies as a small servicer if it either (a) services, together with any affiliates, 5,000 or fewer mortgage loans, for all of which the institution (or an affiliate) is the creditor or assignee, or (b) is a Housing Finance Agency, as defined in 24 C.F.R. §266.5. Qualified lenders are those defined to be qualified lenders under the Farm Credit Act of 1971 and the Farm Credit Administration's accompanying regulations set forth at 12 C.F.R. §617.7000 et seq.

### General Continuity of Contact Policies and Procedures

### 12 C.F.R. §1024.40(a)

Servicers must have policies and procedures that are reasonably designed to assign personnel (one or more persons) to a delinquent borrower at the time the servicer provides the borrower with the written notice required under 12 C.F.R. §1024.39(b), and in any event, not later than the 45th day of the borrower's delinquency. The assigned personnel should be available by telephone to answer the borrower's questions and assist the borrower with available loss mitigation options until the borrower makes two consecutive timely payments under a permanent loss mitigation agreement. If the borrower contacts the assigned personnel and does not receive an immediate live response, the servicer must have policies and procedures reasonably designed to ensure the servicer can provide a live response in a timely manner.

### Functions of Servicer Personnel

### 12 C.F.R. §1024.40(b)

The servicer also must maintain policies and procedures reasonably designed to ensure that the assigned personnel can perform certain functions, including: providing the borrower with accurate information about (1) loss mitigation options available to the borrower from the owner or assignee of the borrower's loan, (2) actions the borrower must take to be evaluated for such options, including the steps the borrower needs to take to submit a complete loss mitigation application and appeal a denial of a loan modification option (if applicable), (3) the status of any loss mitigation application the borrower has submitted, (4) the circumstances under which the servicer may refer the borrower's account to foreclosure, and (5) any loss mitigation deadlines.

The servicer also must have policies and procedures reasonably designed to ensure that assigned personnel are able to (1) timely retrieve a complete record of the borrower's payment history and all written information the borrower has provided to the servicer (or prior servicers) in connection with a loss mitigation application, (2) provide these documents to other people required to evaluate the borrower for loss mitigation options, if applicable, and (3) provide the borrower with information about submitting an error notice or information request under 12 C.F.R. §1024.35 or 12 C.F.R. §1024.36.

### Land Title Industry Response

The American Land Title Association (“ALTA”), founded in 1907, is the national trade association representing approximately 5,500 title companies, title and settlement agents, independent abstractors, title researchers and title attorneys. After the enactment of Dodd-Frank and CFPB Regulations described above, ALTA's Board of Governors, including representatives from both the agent and underwriter communities, began developing performance standards during 2012 for settlement agents to follow as best practices within the industry. On Jan. 2, 2013, as revised on Jul. 19, 2013, ALTA published its “Title Insurance and Settlement Company Best Practices,” which outlines seven types of business practices designed to help protect consumers and lenders in relation to real estate settlement processes. These so-called “Pillars of Best Practices” include a range of policies and procedures to help ensure positive and compliant real estate settlement experiences for consumers and lenders. As ALTA has described, its Best Practices are a benchmark for the real estate settlement and mortgage lending industries, intended to illuminate the high level professionalism that ALTA members follow to protect consumers and businesses involved with real estate and mortgage settlement.

ALTA Best Practice #4

In particular, ALTA Best Practice #4 is “[a]dopt standard real estate settlement procedures and policies that help ensure compliance with Federal and State Consumer Financial Laws as applicable to the Settlement process,” the purpose of which is to adopt “appropriate policies conducting ongoing employee training helps ensure the Company can meet state, federal, and contractual obligations governing the Settlement.”

The following procedures are part of this best practice:

A. Recording Procedures

1. Review legal and contractual requirements to determine Company obligations to record documents and incorporate such requirements in its written procedures.

2. Submit or ship documents for recording to the county recorder (or equivalent) or the person or entity responsible for recording within two (2) business days of the later of (i) the date of Settlement, or (ii) receipt by the Company if the Settlement is not performed by the Company.

3. Track shipments of documents for recording.

4. Ensure timely responses to recording rejections.

5. Addressing rejected recordings to prevent unnecessary delay.

6. Verify that recordation actually occurred and maintain a record of the recording information for the document(s).

The disclosed exemplary embodiments are designed to assist the title agent in monitoring adherence to these Section A (“recording procedures”) ALTA Best Practices #4.

B. Pricing Procedures

1. Maintain written procedures to help ensure that customers are charged the correct title insurance premium and other rates for services provided by the Company. These premiums and rates are determined by a mix of legal and contractual obligations.

2. Utilize rate manuals and online calculators, as appropriate, to help ensure correct fees are being charged for title insurance policy premiums, state-specific fees and endorsements.

3. Ensure discounted rates are calculated and charged when appropriate, including refinance or reissue rates.

4. Quality check files after Settlement to help ensure consumers were charged the company's established rates.

5. Provide timely refunds to consumers when an overpayment is detected.

ALTA Best Practice #5

ALTA Best Practice #5 is “[a]dopt and maintain written procedures related to title policy production, delivery, reporting and premium remittance,” the purpose of which is to “ensure adoption of appropriate procedures for production, delivery & remittance of title insurance policies to ensure title companies can meet their legal and contractual obligations.”

The following procedures are part of this best practice:

A. Procedures to meet this best practice:

1. Title policy production and delivery.

2. Title insurance policies are issued and delivered to customers in a timely manner to meet statutory, regulatory or contractual obligations.

3. Issue and deliver policies within thirty days of the later of (i) the date of Settlement, or (ii) the date that the terms and conditions of title insurance commitment are satisfied.

4. Premium reporting and remittance.

5. Title insurance policies are reported and premiums are remitted to the underwriter in a timely manner to meet statutory, regulatory or contractual obligations.

6. Report policies (including a copy of the policy) to underwriter by the last day of the month following the month in which the insured transaction was settled.

7. Remit premiums to underwriter by the last day of the month following the month in which the insured transaction was settled.

The disclosed exemplary embodiments are designed to assist the title agent in monitoring adherence to this Section A (“recording procedures”) under ALTA Best Practices #5.

Unlike the CFPB regulations, ALTA's Best Practices are not mandatory but rather are a voluntary tool endorsed by the industry's leading trade association to help the title industry highlight safeguards in place to ensure that closing activities meet all applicable laws and regulations.

### SUMMARY OF THE EXEMPLARY EMBODIMENTS

To address one or more of these and/or other needs, the present disclosure includes, among other things, one or more systems, methods and components that facilitate the monitoring, measuring and reporting of processes, such as for example, post-closing processes in real estate purchase and sale transactions, and delivery of documents, such as for example, title insurance policies to insured purchasers of real estate. The present disclosure includes methods and systems for administering an electronic registry, such as for example a title insurance registry, with the system configured to facilitate the measuring of time-based and other performance indicators related to the completion and delivery of documents, such as for example, title insurance policies. The system and method of the disclosure controls and operates via a computer network, the electronic registry by, for example:
Capturing, processing, organizing and storing documents and information, such as for example, title insurance information and title requirements necessary for the fulfillment, effectiveness and delivery of title insurance policies to purchasers of real property and proof of satisfaction thereof;
Retrieving, transmitting and reporting of information, such as for example, title insurance information and title requirements necessary for the transaction;
Monitoring, measuring, scoring and reporting of key performance indicators and other quality metrics, including timeliness, accuracy and variance over time, such as for example, metrics and performance indicators related to title companies' and lien holders' performance of tasks in connection with or necessary for the fulfillment, effectiveness and delivery of title insurance policies to purchasers of real property;
Communicating information, data and documents with key systems, corporations, individuals and players, such as for example, lenders and other lien holders on behalf borrowers and title companies on a timed basis to report, relay and deliver qualified written requests, notices of error and requests for information to lenders under Regulation X to promote and achieve the timely recording of lien satisfactions and releases in accordance with applicable state statutory deadlines;
Certifying and preserving information, data and documents, such as for example, title insurance information providing audit-ready proof of lien release satisfaction to buyers and sellers of real property, title companies, title insurance underwriters, lenders and others, including satisfaction of title requirements necessary for the fulfillment, effectiveness and delivery of title insurance policies to purchasers of real property; and
Preparing and delivering information, data and documents, such as for example, title insurance policies to purchasers of real property, title companies, title insurance underwriters and mortgagees.

One exemplary embodiment of the disclosure is the analytical and comparative tools in monitoring, measuring and reporting various metrics and parameters of the real estate transaction and process, such as provision of a scorecard for the lender, title company, consumer borrower and others. The scalable metrics and parameters may also be depicted in a dashboard interface accessible by the lender, title company, consumer borrower and others. Another exemplary embodiment includes a delivery feature of the title insurance and policy, which may be achieved through simultaneous delivery to the title insurance agency, title insurance underwriter and mortgagee in electronic or hard copy format.

In many instances a title agency's performance under conventional systems resulted in insufficient, ineffective and undocumented follow-up with lien holders, which exposes the title agency and lender to a risk of violating RESPA, specifically Regulation X, and to the risk of negative publicity. This also potentially exposes the title agency and lender to damage to or loss of business relationships and expenses, penalties and fines under prevailing CFPB regulations. Thus, to promote the efficiency and effectiveness of the entire post-closing process in real estate purchase and sale transactions, from the consummation of the transaction up to and including delivery of the title insurance policy to the insured purchaser of the real property, the exemplary system uniquely monitors, measures and reports on the key performance indicators and other performance analytics of title agents and lien holders, including mortgage lenders, in relation to the title insurance delivery process. The exemplary embodiments also automate the delivery of title insurance policies to insureds once all conditions to delivery of each such policy has been satisfied and fulfilled.

### BRIEF DESCRIPTION OF THE DRAWINGS

Various other objects, features and attendant advantages of the present device, systems, and method will become fully appreciated as the same becomes better understood when considered in conjunction with the accompanying drawings, wherein:

FIG. 1 is an exemplary flowchart of conventional art systems regarding title insurance policy production and claim response;

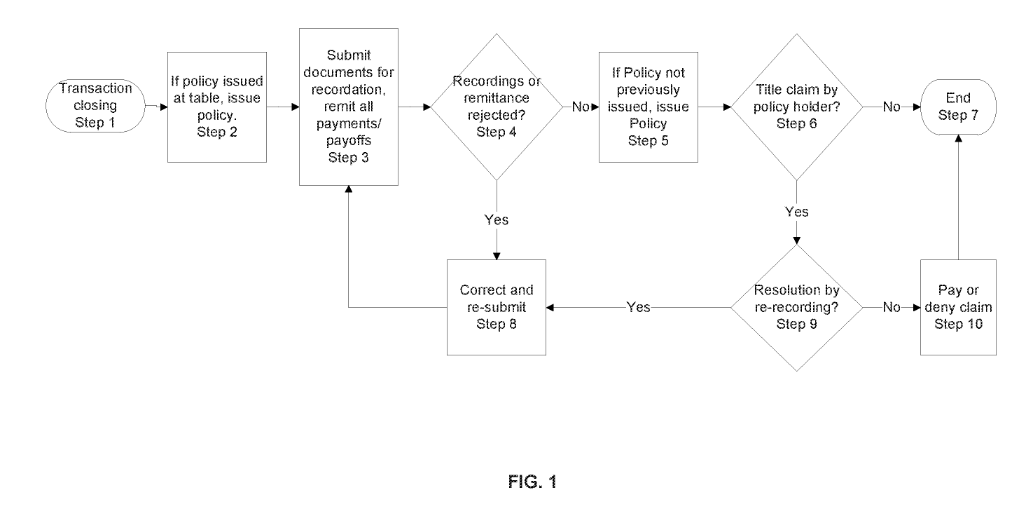

FIG. 2 is a flowchart showing steps involved in the Scorecard System of an exemplary embodiment for Financial Service Providers;

FIG. 3 is a flowchart showing steps involved in the fee compliance module;

FIG. 4 is a schematic of Suppliers, Inputs, Process, Outputs, and Controls involved in the exemplary system;

FIG. 4A is a flowchart showing exemplary steps involved of an exemplary embodiment for interrelating the Suppliers, Inputs, Process, Outputs, and Controls;

FIG. 5 is a flowchart showing steps involved in the Information Quality Assurance module of an exemplary embodiment;

FIG. 5A is a flowchart showing exemplary steps involved in the search process;

FIG. 5B is a flowchart showing further exemplary steps involved in the exemplary embodiment in the search process;

FIG. 5C is a flowchart showing further exemplary steps involved in the exemplary embodiment in the search process;

FIG. 5D is a flowchart showing exemplary steps involved in the show and reveal process;

FIG. 6 is a flowchart showing steps involved in an exemplary embodiment, particularly the notification process;

FIG. 7 is a flowchart showing steps involved in the title policy delivery in an exemplary embodiment;

FIG. 8 is a flowchart showing steps involved in the exemplary embodiment;

FIG. 9 is an exemplary scorecard for transactions; and,

FIG. 10 is an exemplary calculator for suggested strategies.

### DETAILED DESCRIPTION OF EXEMPLARY EMBODIMENTS

### Definitions

Application means the submission of a borrower's financial information in anticipation of a credit decision relating to a federally related mortgage loan, which shall include the borrower's name, the borrower's monthly income, the borrower's social security number to obtain a credit report, the property address, an estimate of the value of the property, the mortgage loan amount sought, and any other information deemed necessary by the loan originator. An application may either be in writing or electronically submitted, including a written record of an oral application.

Business day means a day on which the offices of the business entity are open to the public for carrying on substantially all of the entity's business functions.

Dealer loan or dealer consumer credit contract means, generally, any arrangement in which a dealer assists the borrower in obtaining a federally related mortgage loan from the funding lender and then assigns the dealer's legal interests to the funding lender and receives the net proceeds of the loan. The funding lender is the lender for the purposes of the disclosure requirements. If a dealer is a “creditor” as defined under the definition of “federally related mortgage loan,” the dealer is the lender for purposes of this definition.

Effective date of transfer is defined in section 6(i)(1) of RESPA (12 U.S.C. §2605(i)(1)). In the case of a home equity conversion mortgage or reverse mortgage as referenced in this section, the effective date of transfer is the transfer date agreed upon by the transferee servicer and the transferor servicer.

Federally related mortgage loan or mortgage loan means as follows:

(1) Any loan (other than temporary financing, such as a construction loan):

(i) That is secured by a first or subordinate lien on residential real property, including a refinancing of any secured loan on residential real property upon which there is either:
(A) Located or, following settlement, will be constructed using proceeds of the loan, a structure or structures designed principally for occupancy of from one to four families (including individual units of condominiums and cooperatives and including any related interests, such as a share in the cooperative or right to occupancy of the unit); or
(B) Located or, following settlement, will be placed using proceeds of the loan, a manufactured home; and

(ii) For which one of the following paragraphs applies. The loan:
(A) Is made in whole or in part by any lender that is either regulated by or whose deposits or accounts are insured by any agency of the Federal Government;
(B) Is made in whole or in part, or is insured, guaranteed, supplemented, or assisted in any way:
   (1) By the HUD Secretary or any other officer or agency of the Federal Government; or
   (2) Under or in connection with a housing or urban development program administered by the HUD Secretary or a housing or related program administered by any other officer or agency of the Federal Government;
(C) Is intended to be sold by the originating lender to the Federal National Mortgage Association, the Government National Mortgage Association, the Federal Home Loan Mortgage Corporation (or its successors), or a financial institution from which the loan is to be purchased by the Federal Home Loan Mortgage Corporation (or its successors);
(D) Is made in whole or in part by a “creditor”, as defined in section 103(f) of the Consumer Credit Protection Act (15 U.S.C. §1602(f)), that makes or invests in residential real estate loans aggregating more than $1,000,000 per year. For purposes of this definition, the term “creditor” does not include any agency or instrumentality of any State, and the term “residential real estate loan” means any loan secured by residential real property, including single-family and multifamily residential property;
(E) Is originated either by a dealer or, if the obligation is to be assigned to any maker of mortgage loans specified in paragraphs (1)(ii)(A) through (D) of this definition, by a mortgage broker; or
(F) Is the subject of a home equity conversion mortgage, also frequently called a “reverse mortgage,” issued by any maker of mortgage loans specified in paragraphs (1)(ii)(A) through (D) of this definition.

(2) Any installment sales contract, land contract, or contract for deed on otherwise qualifying residential property is a federally related mortgage loan if the contract is funded in whole or in part by proceeds of a loan made by any maker of mortgage loans specified in paragraphs (1)(ii)(A) through (D) of this definition.

(3) If the residential real property securing a mortgage loan is not located in a State, the loan is not a federally related mortgage loan.

Good faith estimate (“GFE”) means an estimate of settlement charges a borrower is likely to incur, as a dollar amount, and related loan information, based upon common practice and experience in the locality of the mortgaged property.

HUD means the U.S. Department of Housing and Urban Development.

HUD-1 or HUD-1A settlement statement (also HUD-1 or HUD-1A) means the statement that is prescribed by the HUD Secretary for setting forth settlement charges in connection with either the purchase or the refinancing (or other subordinate lien transaction) of 1- to 4-family residential property.

HUD Secretary means the Secretary of the U.S. Department of Housing and Urban Development.

Lender means, generally, the secured creditor or creditors named in the debt obligation and document creating the lien. For loans originated by a mortgage broker that closes a federally related mortgage loan in its own name in a table funding transaction, the lender is the person to whom the obligation is initially assigned at or after settlement. A lender, in connection with dealer loans, is the lender to whom the loan is assigned, unless the dealer meets the definition of creditor as defined under “federally related mortgage loan” above.

Loan originator means a lender or mortgage broker.

Managerial employee means an employee of a settlement service provider who does not routinely deal directly with consumers, and who either hires, directs, assigns, promotes, or rewards other employees or independent contractors, or is in a position to formulate, determine, or influence the policies of the employer. Neither the term “managerial employee” nor the term “employee” includes independent contractors, but a managerial employee may hold a real estate brokerage or agency license.

Mortgage broker means a person (not an employee of a lender) or entity that renders origination services and serves as an intermediary between a borrower and a lender in a transaction involving a federally related mortgage loan, including such a person or entity that closes the loan in its own name in a table funded transaction. A loan correspondent approved under 24 C.F.R. §202.8 for Federal Housing Administration programs is a mortgage broker for purposes of this definition.

Mortgaged property means the real property that is security for the federally related mortgage loan.

Origination service means any service involved in the creation of a mortgage loan, including but not limited to the taking of the loan application, loan processing, and the underwriting and funding of the loan, and the processing and administrative services required to perform these functions.

Refinancing means a transaction in which an existing obligation that was subject to a secured lien on residential real property is satisfied and replaced by a new obligation undertaken by the same borrower and with the same or a new lender. The following shall not be treated as a refinancing, even when the existing obligation is satisfied and replaced by a new obligation with the same lender (this definition of “refinancing” as to transactions with the same lender is similar to Regulation Z, 12 C.F.R. §226.20(a)):

(1) A renewal of a single payment obligation with no change in the original terms;

(2) A reduction in the annual percentage rate as computed under the Truth in Lending Act with a corresponding change in the payment schedule;

(3) An agreement involving a court proceeding;

(4) A workout agreement, in which a change in the payment schedule or change in collateral requirements is agreed to as a result of the consumer's default or delinquency, unless the rate is increased or the new amount financed exceeds the unpaid balance plus earned finance charges and premiums for continuation of allowable insurance; and

(5) The renewal of optional insurance purchased by the consumer that is added to an existing transaction, if disclosures relating to the initial purchase were provided.

Regulation Z means the regulations issued by the Board of Governors of the Federal Reserve System (12 C.F.R. §226) to implement the Federal Truth in Lending Act (15 U.S.C. §1601 et seq.), and includes the Commentary on Regulation Z.

Required use means a situation in which a person must use a particular provider of a settlement service in order to have access to some distinct service or property, and the person will pay for the settlement service of the particular provider or will pay a charge attributable, in whole or in part, to the settlement service. However, the offering of a package (or combination of settlement services) or the offering of discounts or rebates to consumers for the purchase of multiple settlement services does not constitute a required use. Any package or discount must be optional to the purchaser. The discount must be a true discount below the prices that are otherwise generally available, and must not be made up by higher costs elsewhere in the settlement process.

RESPA means the Real Estate Settlement Procedures Act of 1974, 12 U.S.C. §2601 et seq.

Servicer means the person responsible for the servicing of a mortgage loan (including the person who makes or holds a mortgage loan if such person also services the mortgage loan). The term does not include:

(1) The Federal Deposit Insurance Corporation (“FDIC”) or the Resolution Trust Corporation (“RTC”), in connection with assets acquired, assigned, sold, or transferred pursuant to section 13(c) of the Federal Deposit Insurance Act or as receiver or conservator of an insured depository institution; and

(2) The Federal National Mortgage Corporation (“FNMA”); the Federal Home Loan Mortgage Corporation (“Freddie Mac”); the RTC; the FDIC; HUD, including the Government National Mortgage Association (“GNMA”) and the Federal Housing Administration (“FHA”) (including cases in which a mortgage insured under the National Housing Act (12 U.S.C. §1701 et seq.) is assigned to HUD); the National Credit Union Administration (“NCUA”); the Farmers Home Administration or its successor agency under Public Law 103-354 (“FmHA”); and the Department of Veterans Affairs (“VA”), in any case in which the assignment, sale, or transfer of the servicing of the mortgage loan is preceded by termination of the contract for servicing the loan for cause, commencement of proceedings for bankruptcy of the servicer, or commencement of proceedings by the FDIC or RTC for conservatorship or receivership of the servicer (or an entity by which the servicer is owned or controlled).

Servicing means receiving any scheduled periodic payments from a borrower pursuant to the terms of any mortgage loan, including amounts for escrow accounts under section 10 of RESPA (12 U.S.C. §2609), and making the payments to the owner of the loan or other third parties of principal and interest and such other payments with respect to the amounts received from the borrower as may be required pursuant to the terms of the mortgage servicing loan documents or servicing contract. In the case of a home equity conversion mortgage or reverse mortgage as referenced in this section, servicing includes making payments to the borrower.

Settlement means the process of executing legally binding documents regarding a lien on property that is subject to a federally related mortgage loan. This process also may be called “closing” or “escrow” in different jurisdictions.

Settlement service means any service provided in connection with a prospective or actual settlement, including, but not limited to, any one or more of the following:

(1) Origination of a federally related mortgage loan (including, but not limited to, the taking of loan applications, loan processing, and the underwriting and funding of such loans);

(2) Rendering of services by a mortgage broker (including counseling, taking of applications, obtaining verifications and appraisals, and other loan processing and origination services, and communicating with the borrower and lender);

(3) Provision of any services related to the origination, processing or funding of a federally related mortgage loan;

(4) Provision of title services, including title searches, title examinations, abstract preparation, insurability determinations, and the issuance of title commitments and title insurance policies;

(5) Rendering of services by an attorney;

(6) Preparation of documents, including notarization, delivery, and recordation;

(7) Rendering of credit reports and appraisals;

(8) Rendering of inspections, including inspections required by applicable law or any inspections required by the sales contract or mortgage documents prior to transfer of title;

(9) Conducting of settlement by a settlement agent and any related services;

(10) Provision of services involving mortgage insurance;

(11) Provision of services involving hazard, flood, or other casualty insurance or homeowner's warranties;

(12) Provision of services involving mortgage life, disability, or similar insurance designed to pay a mortgage loan upon disability or death of a borrower, but only if such insurance is required by the lender as a condition of the loan;

(13) Provision of services involving real property taxes or any other assessments or charges on the real property;

(14) Rendering of services by a real estate agent or real estate broker; and

(15) Provision of any other services for which a settlement service provider requires a borrower or seller to pay.

State means any State of the United States, the District of Columbia, the Commonwealth of Puerto Rico, and any territory or possession of the United States.

Table funding means a settlement at which a loan is funded by a contemporaneous advance of loan funds and an assignment of the loan to the person advancing the funds.

Third party means a settlement service provider other than a loan originator.

TILA means the Truth in Lending Act of 1968 (Pub.L 90-321, 15 U.S.C. §41 Section 1601).

Title company means any institution, or its duly authorized agent, that is qualified to issue title insurance.

Title policy means a policy issued by an insurance company guaranteeing that the title to a parcel of real property is clear and properly in the name of the title owner, and that the owner has the right to deed the property (convey or sell) to another, which typically is required if the property is under mortgage with a lender. Should a problem later arise with the title (such as an inaccurate description), the insurance company will pay the damages to the new title holder or secured lender or take steps to correct the problem. Most title insurance is lender's title insurance, which is paid for by the borrower but protects only the lender. Another type of title policy, called owner's title insurance, is a separate policy that is paid for by the seller of real property to protect the buyer's interest in the property. While a lender's policy only protects the lender against loss, the fact that the policy was issued reflects that a title search has taken place, which can give some assurance to the buyer and lender/mortgagee. However, title searches are not 100% infallible, hence the need for insurance.

Title service means any service involved in the provision of title insurance (lender's or owner's policy), including but not limited to: title examination and evaluation; preparation and issuance of title commitment; clearance of underwriting objections; preparation and issuance of a title insurance policy or policies; and the processing and administrative services required to perform these functions. The term also includes the service of conducting a settlement.

### Monitoring and Measuring

### Financial Service Providers Scorecard System

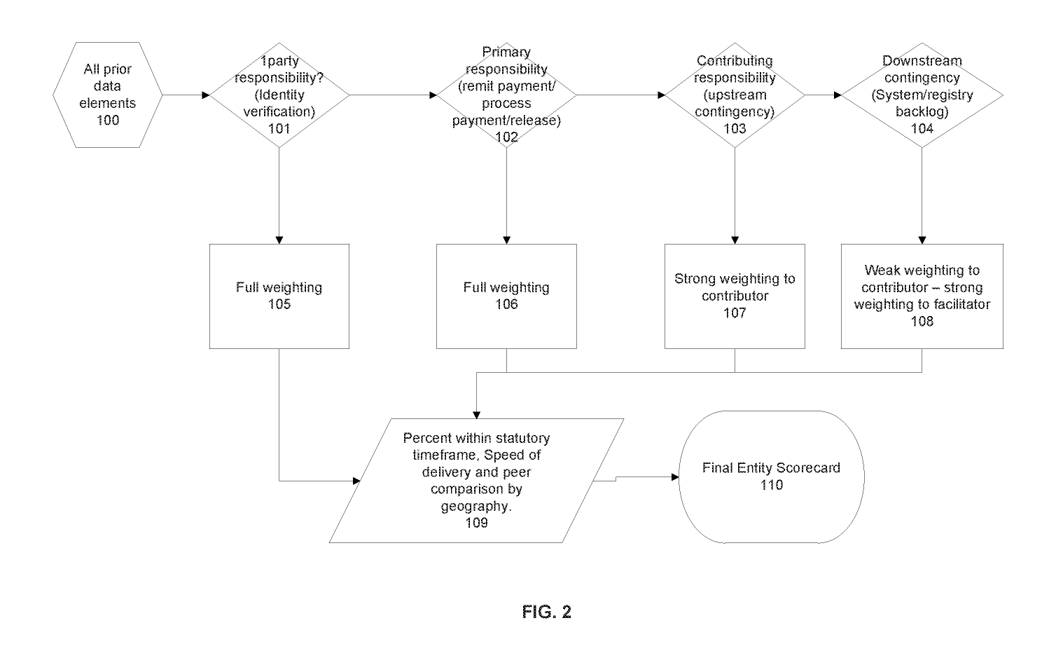

### FIG. 2

A scorecard of the disclosed system can provide the measurement and reporting of, among other things, various performance indicators and business analytics derived from the system's processes and methodology. This scorecard can be issued in some periodic basis, typically monthly and quarterly, for at least various efficiency and effectiveness parameters, such as the efficiency and effectiveness of title companies, lenders and other third parties in relation to tasks necessary during the post-closing processes of a real estate settlement for title policy delivery.

FIG. 2 provides an overview of how the disclosed system weights various metrics for attribution to the “score” of any particular lender, title company, consumer borrower, and other contributor to a transaction, such as a real estate transaction, for reflection in a scorecard. As shown in FIG. 2, step 100, the system gathers a multitude of data elements both automatically through interaction and data feeds with various systems, and through manual retrieval, digital interaction on the backend of the database, or direct interaction with the system's scoring analytics itself. These data requirements are essential for the accuracy and weighting of the system product's scorecard.

One product of the system is a component/service provider as well as a service/industry rating or score. In contrast to some rating models which wholly rely on consumer opinion in the rating or score, the exemplary embodiment of the disclosed system is not intended to be primarily opinion based, as the validity of each opinion based claim can be suspect, and subject to numerous methods of influencing the result by anonymous entries, fraudulent entries, automated entries, etc. Alternative embodiments of the system, however, are capable of handling opinion based data and can include such subjective opinion based claims or factors.

The disclosed system assesses and scores individual components of the delivery chain in addition to the delivery service as a whole with qualitative and quantitative sub-scores for factors which contribute to the overall score. This allows the components and service being scored to more easily determine how to improve the individual component score and overall score.

The disclosed scoring system may be applied to any industry or service with multiple touch points, including the use of the disclosed system for the financial services industry described herein.

The data sources and the various systems that contribute to the system's use, for example, creation, submission, receipt, processing, billing, confirmation of processing, accounting, delivery to the public record, quality control and other validation of services provided, may have a proprietary nature to their process individually. However, the objective of the system is not to replace the sub-systems, but rather to act as an independent control and measurement mechanism for the effectiveness of each component of the delivery chain and its effect on the supply chain as a whole, both qualitatively and quantitatively.

It is anticipated that the system only needs public data and related metadata (i.e., structural or descriptive data about the public data) to provide an accurate scorecard, however the system receives, transmits, processes and retains all data in a secured manner whenever possible to protect the proprietary nature of the score carding system and the integrity of the scores/scorecards produced.

Referring to FIG. 2, Critical to Quality (“C2Q”) data points within the overall delivery chain are designated either as a data point where a service provider bears sole/primary/contributing or facilitating responsibility for fulfillment of the task(s) related to the data point. Examples of the C2Q data points are depicted in elements 101 through 104 in FIG. 2. For example, the closing agent is responsible to ensure all transaction documents are signed and notarized where necessary. The closing agent is the single party that bears this responsibility and this C2Q data point is exemplary of the data collected in element 101. As the single responsible party, the closing agent bears full weighting of this metric, as reflected in element 105, and full attribution to the agent's scorecard. As another example, the recorder in a land record office is a downstream C2Q point as the recorder is waiting for delivery of the title from the title company for recording. Thus, as reflected in element 104 and 108, a weaker weighting is applied to the recorder as a “downstream contingency,” and a stronger weighting to the title company as the “facilitator,” for attribution in a scorecard for adverse scenarios where the title company chose to transmit the title through slower U.S. mail delivery instead of faster e-delivery. For weighting of C2Q data points of responsibilities in between those reflected in elements 105 and 108, elements 106 and 107 illustrate variations in attribution.

As illustrated in steps 105 through 108, the exemplary score/scorecard allows for a variable weighting based on the amount of responsibility or control each contributor has towards the completion delay, or lack of completion for each particular data point. Due to the complexity of each deliverable, the variable weighting within the scorecard is specific to the deliverable (product/service/industry) being measured and subject to the algorithm or weighting formula. The following is to clarify how the exemplary embodiments are able to accommodate variable weighting, and the resulting benefit.

The final scoring in a scorecard is related to the comparison of delivery timeframe against the regulatory timeframe (if any) and then additional scoring based off of performance better than required, i.e., actual delivery before expiration of the regulatory timeframe. For example, below is a Table 1 illustrating a final score that may be used in a scorecard for comparing various title companies against a metric for delivery of title insurance and policy.

TABLE 1

| | | Industry | | | |
|---|---|---|---|---|---|
| | | standard - | | | |
| | | Delivery | | | |
| | Delivery | within | Average | Sub-process | |
| | Method | 30 days | time | failure | |
| Company A | Overnight | 100% | 2.5 days | 1 - tracking alert, | A |
| | delivery | | | able to re-sign | |
| | | | | and re-submit | |
| | | | | within target. | |
| Company B | Courier | 100% | 1.8 hours | 0 | A+ |
| Company C | Postal | 99% | 5 days | 1 - delivery lost - | A− |
| | Mail | | | no tracking | |
| Company D | E-delivery | 100% | .75 hours | 0 | A+ |

Table 1 reflects an exemplary scorecard for title companies in compliance with the delivery of title insurance policies, which is a non-regulated metric. Although it is unregulated, ALTA Best Practice #5 provides an industry standard that title companies should “issue and deliver policies within thirty days of the later of (i) the date of Settlement, or (ii) the date that the terms and conditions of title insurance commitment are satisfied.” Because the industry may desire a letter-type grade, the scorecard can provide one.

As reflected in Table 1, the time allotted to the grading of each task is related to the various industry standards in the delivery pipeline (e.g., Postal mail delivery: typically 3 to 7 days; overnight delivery: next, second or third day depending on drop-off time and delivery selection pricing; courier delivery to the recorder's office: next or second day; etc.) The submitter, here the title company, is responsible for their choice of delivery methods, however they may not be responsible for the failure of the delivery method unless the delivery method causes a process failure, or if they continue to use it after multiple failures. As shown in Table 1, if a regulatory timeframe exists and all methods achieve the timeframe, the scorecard for a company that chooses e-delivery would be very similar to a company that chooses to hand deliver because of their proximity, however a company that chooses overnight delivery would trail behind, and a submitter that chooses regular mail would trail even further and may be the cause for a process failure. For example, as seen in the “Sub-process failure” column, for Company A, which submits and tracks title submissions through overnight delivery, it experienced one delivery failure. But, since Company A was able to track its submission, it was able to have the title papers re-signed and re-submitted within the industry standard 30 days. However, Company C, which delivered by U.S. postal mail, had either no such tracking in place or did not adequately monitor the submission, and it experienced a delivery failure. Thus, Company C, as compared to Company A, received a lower grade. The other companies B and D, in this example Table 1, received higher grades because they did not experience any delivery issues as compared to its peers.

The system will naturally encourage users being scored to use the most efficient method while allowing balancing for cost and performance, and would encourage users to discontinue use of inferior methods, or methods with a higher failure rate.

But, there are many other factors outside of a Title Company's selection of delivery method which may also affect overall product or service delivery, including availability of services, frequency of services, government office or other facilitator availability and lag times.

For example, comparing service providers in different geographies can lead to a false impression that a particular service provider is sub-par, when in actuality the service provider is providing the absolute best service available within the constraints of the facilitating services and/or participating governmental agencies and other public or private organizations upon which ultimate performance and results rely. For example, geography with a non-computer based government facilitator with high volumes and therefore high lag times naturally would have a lower overall service delivery than an automated, computer-based government facilitator with low volumes relative to their throughput capacity.

While the industry scorecard should be lower due to the extended delivery time, the underlying score(s) should only reflect that the government facilitator is subpar when compared to its peers within the same geographical location.

In an opposite scenario, if a service provider for a component has the ability to process in an automated digital manner but elects not to do so, the score(s) would indicate that the facilitator is operating well within the standards of its geographic peers; however, in this scenario, the score may indicate that the individual service provider has not adopted the best practice necessary to remain competitive.

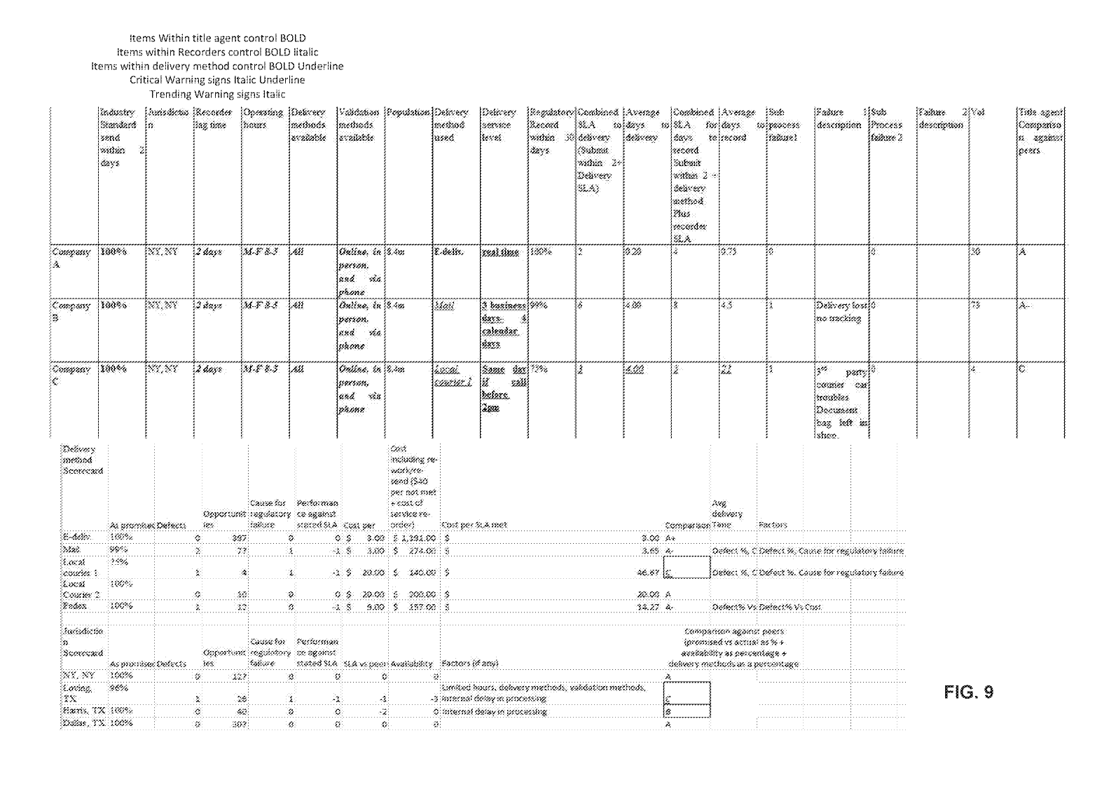

In addition to the component weighting, when statutory/regulatory/industry timeframes and standards are present, the data is compared against each regulation or standard and then compared to peer data within the same geography, which allows valid comparison when opportunity to perform is constant. This is illustrated in FIG. 2, element 109, as well as in FIG. 9, which depicts comparative processing times in a exemplary “Scorecard” for transactions starting with signatures on real estate settlement transactions to the recording of title paperwork with the land record offices of various jurisdictions.

Due to the complexity of each deliverable, the overall scorecard is specific to the deliverable (product/service/industry) being measured. The following description, with reference to the exemplary scorecard in FIG. 9, depicts how the exemplary disclosed system is able to accommodate peer weighting, and the resulting benefit.

As illustrated in Table 1, if the metric established were that the top score required completion of 99% or better within the specified timeframe, the final comparison against peers could appear as shown with respect to the single metric of delivery of title papers to the recorder.

But, in FIG. 9, additional metrics are illustrated to show scores of individual title company peers in a scorecard. For example, Companies A, B, and C only have transactions in New York, and should not be compared against Companies 1, and 2 as direct peers because none of their transactions had an equal opportunity to perform.

While in the same industry, which requires delivery within 30 days under ALTA Best Practice #5, only companies that perform transactions in jurisdictions with similar restrictions in which the companies have the same opportunity to perform should be considered peers.

In the FIG. 9 example, companies operating in jurisdictions in New York, N.Y.; Dallas, Tex.; and Harris, Tex. all have the same opportunity to perform (same operating hours for the jurisdiction's land records office and same acceptable delivery methods, namely “all”). So, Companies A, B, C and 3 all operate within the same constraints and can be compared and considered peers. Within this peer group Company C stands out as the weak performer, as explained in more detail below.

But, transactions in Loving, Tex. (the least populous county in the U.S.) may not have the same opportunity to perform due to limited office hours and delivery methods. As seen in FIG. 9, the land records office in Loving, Tex. does not accept e-delivery of title paperwork. Thus, offices of companies operating in this jurisdiction may not be considered and scored against others due to this limitation.

But with respect to the peer group of Companies A, B, C and 3, which all operate within the same constraints, Company C stands out as the weak performer. Although Company C utilizes courier service, which is faster than U.S. mail delivery service method selected by Company B, in FIG. 9, it received a lower score in part because it experienced a failure on the part of its courier (e.g., as noted in a column of FIG. 9, its third party courier experienced car trouble and left the title papers in car shop, resulting in a failure of title recordation within the industry standard of 30 days). Because of the low volume for Company C, this singular failure resulted in a low performance rate of recording titles within 30 days, as compared to its peers. Company B had one failure as well, but because it had a higher volume, it received a better grade than Company C despite its slower delivery method.

Further, as reflected in FIG. 9, although Company C operates only in New York, where the recording office takes on average 2 days to process titles, it has a lower score than Company 3, which has several branches, including two that operate in Loving, T X and Harris, Tex., where those respective recording offices take on average 7 and 21 days, respectively, to process titles. In addition, Company 3 received a higher overall score than Company C despite the fact that it used slower U.S. mail service to deliver paperwork to the Loving, Tex. recording office.

Within the peer group of companies operating in Loving, Tex., as illustrated in FIG. 9, Company 3 is the weak performer. As seen in the illustration in FIG. 9, Company 3 had low volume with one failed delivery due to lack of package tracking. Thus, within the Loving, Tex. peer group, it had the lowest score. However due to the large number of total transactions of Company 3 in other jurisdictions with much higher volume and success, such as in its Dallas and Harris, Tex., branches, Company 3 remains a top performer overall. Company C just did not have enough performing transactions in to offset its lone failure in Loving, Tex.

The representative scorecard illustrated in FIG. 9 can also compare various delivery methods across various companies. As seen at the bottom of FIG. 9, the failure rate of disparate delivery methods are calculated, along with the cost associated with each failure rate. Grades and scores for each delivery method are also provided by the exemplary system.

In addition, performance of various land record agencies of various jurisdictions can also be calculated with associated grades and scores of each. Attributable failure factors (e.g., the limited delivery methods permitted in the Loving, Tex. office and the long lag time of 21 days for the Harris, Tex. office) can also be flagged by the exemplary system. Percentages of successful delivery and recording are calculated as a percentage of actual delivery versus promised or industry standard delivery times.

These advanced analytics will be able to measure, monitor, compare and track numerous factors, some of which are depicted in FIG. 9. There are an abundant number of key performance indicators, parameters and other quality metrics that the disclosed system monitors, measures, scores and reports. The exemplary system and method statically and dynamically measures, monitors, compares and tracks these data, including for example, the timeliness, accuracy, and variance over time, of title companies' and lien holders' performance of tasks in connection with or necessary for the fulfillment, effectiveness and delivery of title insurance policies to purchasers of real property. The exemplary system and method also monitors, measures, compares, tracks and reports the following key performance indicators on a daily, weekly, monthly, quarterly and annual basis:

(a) Files:

(1) total number of files, such as real estate transaction files, (2) total number of files closed, (3) total number of files pending; (4) percentage of files closed, (5) total percentage of files closed, (6) percentage of files pending, (7) total number of files closed prior to statutory deadline, (8) total number of files pending 30 days or less; (9) total number of files pending 60 days or less, (10) total number of files pending 90 days or less, (11) total number of files pending greater than 30 days; (12) total number of files pending greater than 60 days, (13) total number of files pending greater than 90 days, (14) total number of files pending less than the state's statutory deadline, (15) total number of files pending greater than the state's statutory deadline, (16) total percentage of files pending 30 days or less; (17) total percentage of files pending 60 days or less, (18) total percentage of files pending 90 days or less, (19) total percentage of files pending greater than 30 days; (20) total percentage of files pending greater than 60 days, (21) total percentage of files pending greater than 90 days, (22) total percentage of files pending less than the state's statutory deadline, (23) total percentage of files pending greater than the state's statutory deadline;

(b) Title Requirements:

(1) total number of title requirements, such as for example, real estate title requirements (2) total number of title requirements closed, (3) total number of title requirements pending; (4) percentage of title requirements closed, (5) total percentage of title requirements closed, (6) percentage of title requirements pending, (7) total number of title requirements closed prior to statutory deadline, (8) total number of title requirements pending 30 days or less; (9) total number of title requirements pending 60 days or less, (10) total number of title requirements pending 90 days or less, (11) total number of title requirements pending greater than 30 days; (12) total number of title requirements pending greater than 60 days, (13) total number of title requirements pending greater than 90 days, (14) total number of title requirements pending less than the state's statutory deadline, (15) total number of title requirements pending greater than the state's statutory deadline, (16) total percentage of title requirements pending 30 days or less; (17) total percentage of title requirements pending 60 days or less, (18) total percentage of title requirements pending 90 days or less, (19) total percentage of title requirements pending greater than 30 days; (20) total percentage of title requirements pending greater than 60 days, (21) total percentage of title requirements pending greater than 90 days, (22) total percentage of title requirements pending less than the state's statutory deadline, (23) total percentage of title requirements pending greater than the state's statutory deadline;

(c) Title Requirements by Category (for example, individual categories such as Real Estate Purchase Money Mortgage, Mortgage/Deed of Trust, Taxes, Judgments, Notice of Completion, Other Liens, etc.)

(1) total number of each title requirement, (2) total number of each closed, (3) total number of each pending; (4) percentage of each closed, (5) total percentage of each closed, (6) percentage of each pending, (7) total number of each closed prior to statutory deadline, (8) total number of each pending 30 days or less; (9) total number of each pending 60 days or less, (10) total number of each pending 90 days or less, (11) total number of each pending greater than 30 days; (12) total number of each pending greater than 60 days, (13) total number of each pending greater than 90 days, (14) total number of each pending less than the state's statutory deadline, (15) total number of each pending greater than the state's statutory deadline, (16) total percentage of each pending 30 days or less; (17) total percentage of each pending 60 days or less, (18) total percentage of each pending 90 days or less, (19) total percentage of each pending greater than 30 days; (20) total percentage of each pending greater than 60 days, (21) total percentage of each pending greater than 90 days, (22) total percentage of each pending less than the state's statutory deadline, (23) total percentage of each pending greater than the state's statutory deadline; (24) average number of hours between closing and recording of release, (25) average number of days between closing and recording of release, (26) average number of hours between check issuance date (i.e., pay-off) and recording of release, (27) average number of days between check issuance date (i.e., pay-off) and recording of release;

(d) Recording of Purchase Money Mortgage:

(1) average number of hours between closing and recordation of purchase money mortgage, (2) average number of days between closing and recordation of purchase money mortgage;

(e) Title Policy Delivery:

(1) total number of title policies delivered, (2) total number of title policies delivered “at the table”, (3) percentage of title policies delivered “at the table”, (4) total number of title policies delivered post-closing, (5) total percentage of title policies delivered post-closing, (6) average number of hours between closing and delivery of title insurance policy—all policies, (7) average number of days between closing and delivery of title insurance policy—all policies, (8) average number of hours between closing and delivery of title insurance policy—all post-closing policies, (9) average number of days between closing and delivery of title insurance policy—all post-closing policies, (10) average number of hours between check issuance date (i.e., pay-off) and delivery of title insurance policy—all post-closing policies, (11) average number of days between check issuance date (i.e., pay-off) and delivery of title insurance policy—all post-closing policies;

(f) Lender Liaison Communications:

(1) total number of lenders, (2) average number of hours between closing and recordation of release—all lenders, (3) average number of days between closing and recordation of release—all lenders, (4) average number of hours between check issuance date (i.e., pay-off) and recordation of release—all lenders, (5) average number of days between check issuance date (i.e., pay-off) and recordation of release—all lenders, (6) average number of hours between closing and recordation of release—all lenders, (7) average number of hours between closing and recordation of release—by lender, (8) average number of days between closing and recordation of release—by lender, (9) average number of hours between check issuance date (i.e., pay-off) and recordation of release—by lender, (10) average number of days between check issuance date (i.e., pay-off) and recordation of release—by lender, (11) total number of releases recorded between closing and applicable statutory deadline, (12) total number of lender releases recorded between check issuance date (i.e., “pay-off”) and applicable statutory deadline, (13) total number of lender releases pending after expiration of the applicable statutory deadline, (14) total number of lender releases pending greater than 30 days after expiration of the applicable statutory deadline, (15) total number of lender releases pending greater than 60 days after expiration of the applicable statutory deadline, (16) total number of lender releases pending greater than 90 days after expiration of the applicable statutory deadline, (17) rank order of lender releases pending after expiration of the applicable statutory deadline from oldest to youngest, (18) rank order of lender releases pending after expiration of the applicable statutory deadline from youngest to oldest, (s) total number of first Tier 2 communications title company delivered to lenders, (19) average number of days after closing title company delivered first Tier 2 communication to lenders, (20) average number of days after check issuance date title company delivered first Tier 2 communication to lenders, (21) total number of second Tier 2 communications title company delivered to lenders, (22) average number of days after closing title company delivered second Tier 2 communication to lenders, (23) average number of days after check issuance date title company delivered second Tier 2 communication to lenders;

(g) Audit Records:

(1) total number of records showing proof of satisfaction, (2) total number of records showing proof of satisfaction by type (e.g., for each of Purchase Money Mortgage, Mortgage/Deed of Trust, Taxes, Judgments, Notice of Completion, Other Liens, etc.), (3) average number of records showing proof of satisfaction per all files.

These analytics can demonstrate where and why performance is faltering in a particular jurisdiction by measuring available options, success rates of each option, and the effect of each segment and option on the process as a whole.

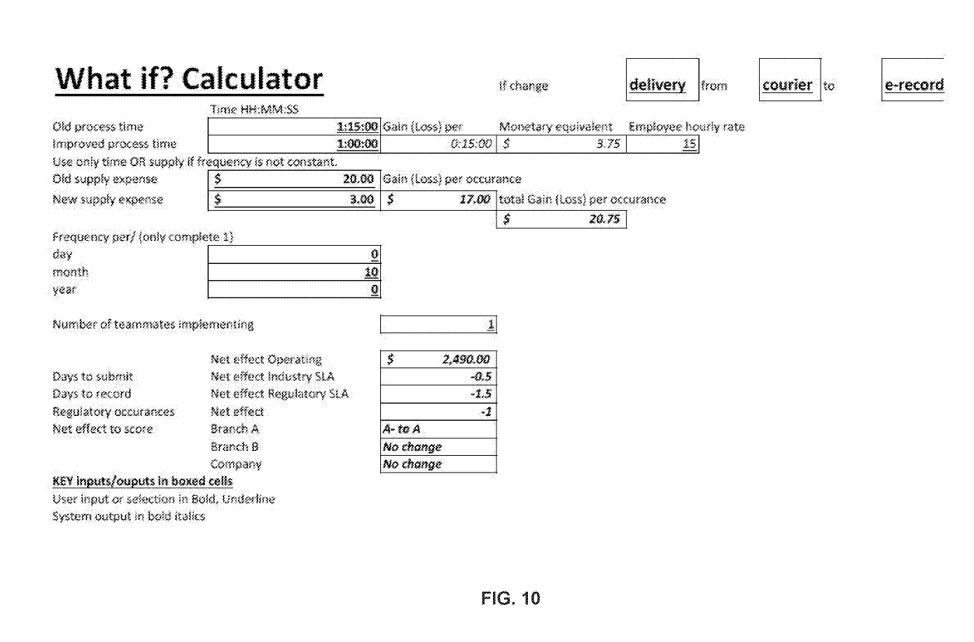

As seen in the exemplary calculator of FIG. 10, the exemplary system may also use the data to pinpoint fault lines of a company's process to suggest other options and strategies for improving a company's score. As shown in an exemplar “What if?” calculator in FIG. 10, the effect of implementing suggested options and strategies are illustrated.

The exemplary calculator of FIG. 10 shows the suggested option of changing the delivery method from courier to e-record (or e-delivery) of title papers to a jurisdiction's land records office. As depicted in FIG. 10, this would shave 15 minutes from processing each title paperwork on average (e.g., a company employee would still need to spend an average of an hour for writing and preparing closing papers, but would save 15 minutes by sending the papers via e-delivery instead of completing shipping sheets and labels for overnight delivery companies and delivering the package for pickup. This savings of 15 minutes at an average employee rate of $15/hour translates to a savings of $3.75 per title. Moreover, e-delivery will save $17 in expenses (i.e., the difference between the shipping rates for courier as opposed to e-delivery). Thus, a company might realize a total savings of $20.75 per title processing. Such savings will translate to a reduction in net operating expenses due to decreases in the cost of man-hour service expenses and cost of delivery expenses.

In addition, implementation of the proposed or suggested delivery change can result in a change to the score of a branch of division of the title company against its peers due to a reduction in processing time as compared to industry or regulatory standards. This is achieved by using the performance data, e.g., the data shown in FIG. 9, to allow comparison of cost, effect on performance against stated Service Levels (SLA), and Industry and Regulatory standards at a regional, branch and corporate level. As reflected in FIG. 10, calculation of changes in performance based on statistical performance of comparative parties and usage rates of either within the entity are reflected. For example, implementation of the proposed change to delivery method to e-record will result in a reduction of a half day under the category of “days to submit” title paperwork, and a further reduction of 1.5 days when stacked against downstream factors such as the number of “days to record” by the land records office. Altogether, this results in one less sub-process failure or one less regulatory failure occurrence, which results in a change of at least Branch A's scorecard. Although beneficial, this change would not impact the score of Branch B or the overall score of the title company, in this example.

### Fee Compliance Module

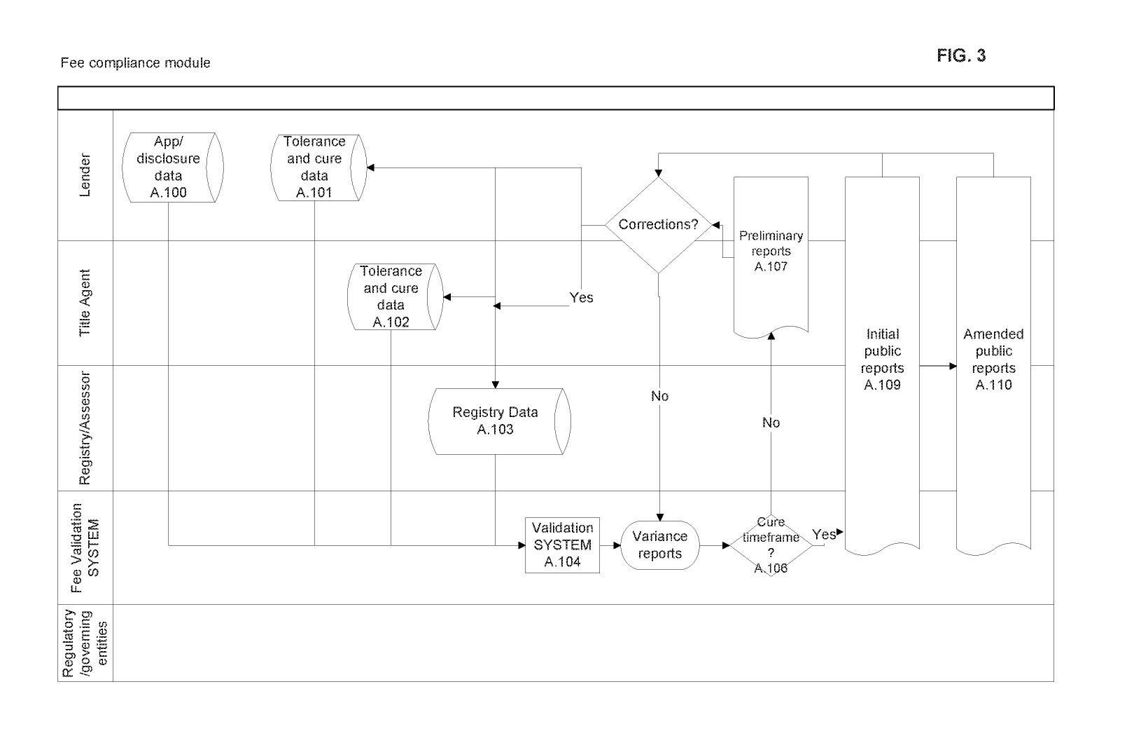

As illustrated in FIG. 3, another area of measurement capable within the disclosed systems and methods relates to validation of the fees shown on the completed public recording of closing documents. There are certain fees and charges involved in transactions, such as real estate transactions. Such fees and charges must be disclosed upfront (e.g., in a Good Faith Estimate). When closing a transaction, the actual fees and charges are required to be within certain tolerance limits of the initially disclosed fees and charges, otherwise the lender is required to absorb any increase. In FIG. 3, an illustration of an exemplary system for tracking compliance with regulations with respect to fees and charges is provided. While other applications may track fees electronically, one aspect of an exemplary embodiment allows the system to validate against the physical receipt printed on the recorded document, where applicable and available in certain jurisdictions.

In FIG. 3, step A100, the system is able to capture original and final disclosure data provided by lenders to consumers. At the time of application, a Good faith Estimate (“GFE”) or Loan Estimate (“LE”) is required by federal law and CFPB regulations to be provided to consumers within a set timeframe (this is considered the baseline cost estimate). If costs are not disclosed within the required timeframe, the baseline is considered to be $0. The fees and charges disclosed are required to be within certain tolerance limits of the actual charges later assessed, otherwise the lender is required to absorb any increase. As more data is gathered to complete the transaction, the services required and their associated fees may change. Only changes requested by the consumer, or a limited set of reasons for permissible changes (also referred to as a valid change in circumstance), are allowed to result in an increase in charges to the consumer.

The system is able to receive data for initial fees disclosed, re-disclosure data, and reasons for the change in data. It is then able to compare this data against permissible reasons for changes to costs within the timeframe of the transaction. Based on the permissible reasons for changes to costs, the system is able to determine when the baseline for fees has been reset due to a valid change in circumstances. Permissible change in circumstances, reasons, or reason codes must be provided with the effective date of the reason code by the lender or entered into the System in order for it to be accepted and available. If a fee change occurs within the regulatory timeframe of when a permissible code is also submitted, a new baseline for all fees will be established. If no acceptable code is submitted, the system will continue to monitor for tolerance violations based on the previous fee baseline.

In FIG. 3, step A101, the system is able to receive and compare data regarding remedies or refunds issued by lenders and their service providers. Remedies also include final and actual costs charged to the consumer i.e. a lender may disclose the increase in cost as required, but elect to absorb the cost, or charge the anticipated cost and refund after all actual expenses are incurred. The system is able to compare remedy data against the most recent baseline and maximum tolerance data and determine whether the remedy brought the consumer costs back to within compliance. The system will also be able to provide data regarding lenders/agents that remedy, even when they are not technically required, as a basis for profit analysis, process improvement and greater peer comparison (e.g., comparison of actual fees/expenses, fees/expenses charged to the consumer, refunds of fees overcharged within regulatory timeframes, refunds issued outside of regulatory timeframe, anticipatory refunds issued when actual costs incurred were greater than disclosed, and fees disclosed less than actual, including disclosures on a cumulative, average, outliers, median, mean, etc. basis).

In FIG. 3, steps A102 to A103, the title agent, as service provider for the lender, also may be processing refunds and remedies to the consumer on behalf of the lender. The system accepts data from the title agent and compares it to the remedies (or anticipated remedies) provided by the lender and applicable tolerances. If the lender has provided a refund to the consumer pre-emptively to maintain compliance, as shown in step A101, the title agent should not duplicate the refund to the consumer, but should refund to the lender. If the lender or agent submits refund data when fees are within tolerance, system will alert the user of current tolerance status.

Steps A104 and A106 of FIG. 3 depict where the system analyzes captured data and compares it against industry and regulatory tables. The system compares data against an index table for industry and regulatory time frames and provides preliminary reports (reports prior to expiration of regulatory timeframe) to agents and/or lenders.

In step A105, the system generates reports for transactions that require a correction or refund based on actual fees compared to disclosed fees and permissible tolerance related to baseline fee amounts if baseline or change in circumstance tracking data is available. If baseline fee data is not available, a correction or refund report is based solely on the closing disclosure or settlement statement compared to actual fees.

In step A106, The system compares data against an index table for industry and regulatory time frames and provides preliminary reports to agents and/or lenders. As mentioned above, new regulations require corrections of fees and charges be processed within thirty days to avoid reporting of violations.

In step A107, Preliminary reports are delivered to agents and/or lenders automatically via email and also are made available by the system on the client's individual website. This allows the agents and/or lenders to monitor compliance with the regulations.

One aspect of the system, among others, is to provide financial service providers the means to better monitor fees to consumers and assist in avoidance of Unfair Deceptive Acts and Practices (“UDAAP”) claims. Individual agent and lender reports may be accessed at any time and may be set to proactively notify agents and lenders so refunds or reimbursements may be issued. This inquiry is depicted as step A108.

In step A109, masked industry data (data which does not disclose individual company identities) may be made available for marketing purposes (the client can use their identity for comparison against the industry and unmasked data may be provided to governing bodies if required).

Additional fee data regarding reimbursements and corrections may require issuance of amended public reports as seen in step A110. Masked industry data may be made available if required by regulatory agencies. This amended report provides information of violations that were not corrected within the thirty-day regulatory timeframe.

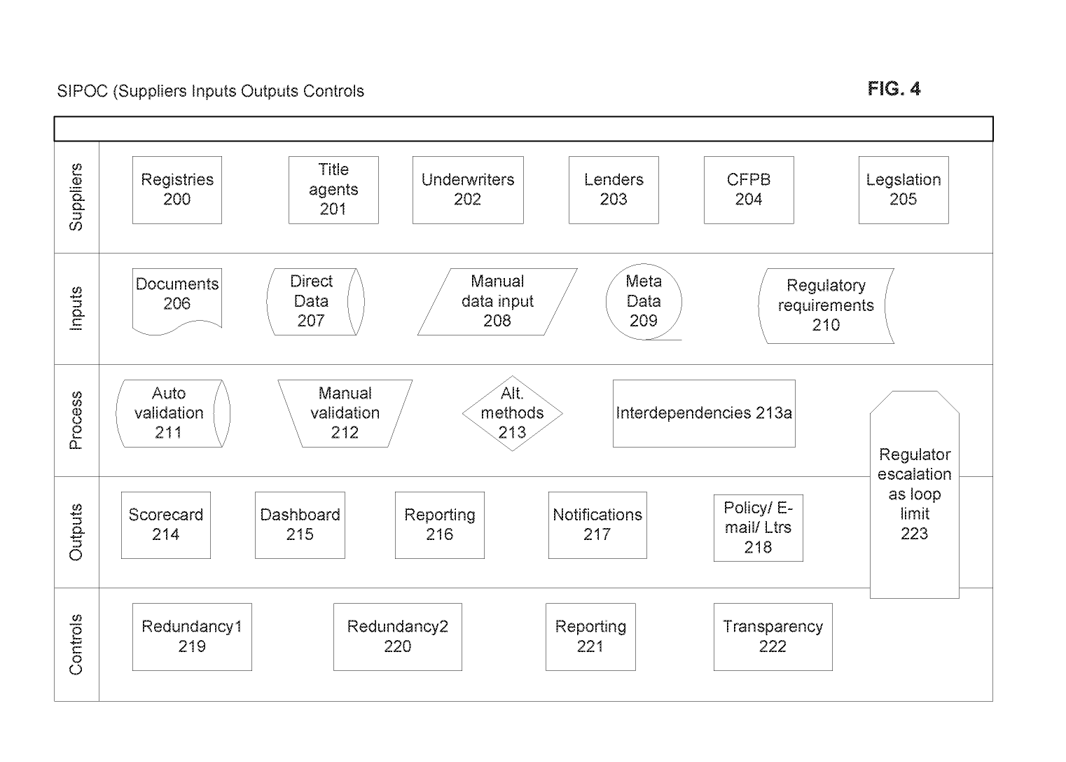

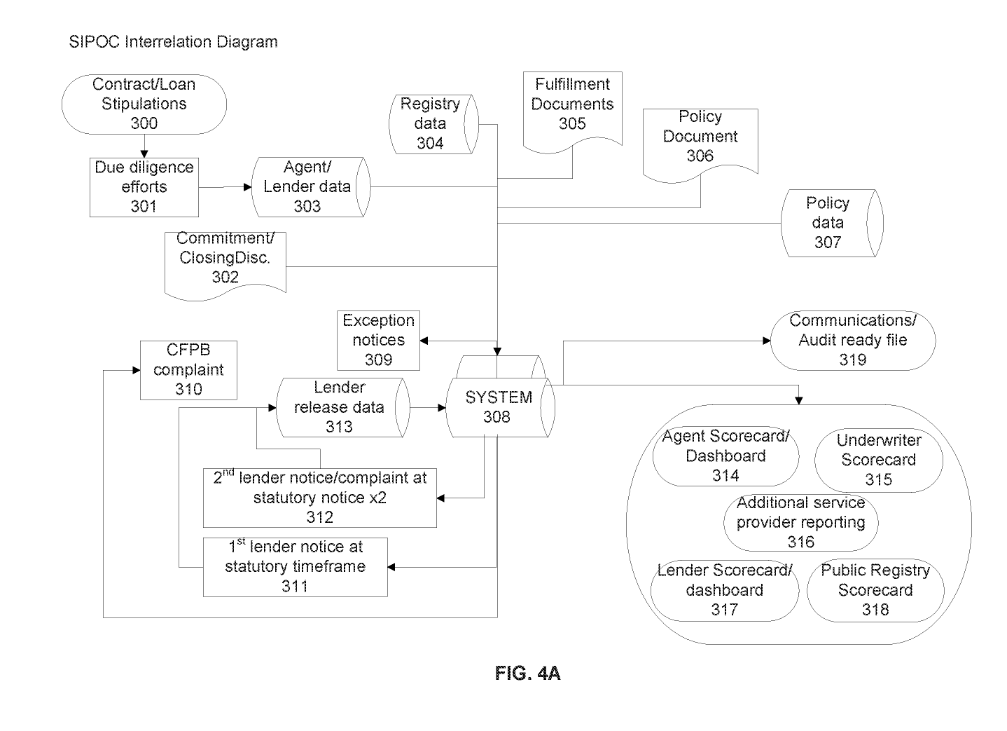

FIG. 4 shows the suppliers of data, data inputs, processes within the exemplary system for comparative analysis, outputs of the system, and controls of the system to ensure the output is correct. FIG. 4 demonstrates how the exemplary embodiment, while an electronic software, creates a tangible service or goods, and which is a significant improvement upon existing methods (which are primarily manual in creation and timing and subject to manual errors/omissions, or are produced prior to actual performance of services) and or quality of creating the service or goods which are necessary for the process.

The system will be able to set parameters for quality monitoring based off of industry requirements, regulatory requirements, and accommodate all data points required to evaluate compliance with industry and regulatory standards.

Data inputs and processes can take many forms and may be input via direct communication or manual input. Evidence of compliance with regulatory requirements will include a completion date, fulfillment document reference, and whenever not considered nonpublic information a copy of the compliance artifact or document.

The system will be able to produce dashboards for the individual user or client, regional and nationwide scorecards and reporting regarding performance of individual title agents, a rollup of all agents producing insurance under a particular underwriter, agent and underwriter performance by lender, as well as notifications, title policies, physical letters, and complaints or notifications to regulators.

Controls within the system ensure the output of the system is correct and include redundancies for data not found through automated processes, redundancy of manual processes, and further escalation through reporting and transparency between all parties.

For the financial services use case, the suppliers of data into the system of the exemplary embodiment as illustrated in FIG. 4 include, but are not limited to suppliers of data for the system such as:
Public record registries 200 and their associated components and technologies, which include among other things, purchaser names, addresses and other information
Title agents 201 and their abstractor network, which provide among other things title policy information and limitations
Underwriters 202, with their agent network, and audit findings
Lenders 203 and their associated third party vendors and related technologies, which provide among other things financial information and closing documents
CFPB 204 and other regulatory agencies, which provide among other things, time frames for various processing steps
Legislative bodies 205 including trade organizations and government.

Expected data inputs from the various suppliers mentioned above include among other things:
Documents 206 which describe the transaction and the requirements needed to evidence completion of the transaction, documents submitted to the public record, documents accepted to public record and documents which provide evidence of fulfillment of transactional obligations which do not require recordation.
Direct data 207 may be transactional data received directly from related systems and technologies.
Manual input data 208, for those suppliers of data that do not have adequate systems integration.
Meta Data 209 for those data components that may be considered sensitive and need to be masked or otherwise encrypted but will still allow industry scoring as required.
Regulatory requirements 210 which provide among other things the time periods for compliance with various regulations and timeframes for compliance with industry standards and guidelines.

As shown in FIG. 4, steps 211 to 213a, the system will validate data elements being ingested in the system 211 and will provide various additional processes which are not possible until the aggregated data is available.

For the use case of financial services, title insurance policies, and other indemnity products are typically contingent on the completion of various tasks/processes.

Referring to FIG. 4, the outputs of the system include, but are not limited to:
Scorecards 214 for individual components, sub-processes, processes and of the interdependent overall process (i.e. appraiser, underwriter, loan officer, title agent, title underwriter, lender, lending industry, etc.)
Dashboards 215 may be limited in scope based on individual user/entity (e.g., title agents only will have access to files with which they are associated, lenders will have access to all files with which they are associated regardless of the agent, underwriters will have access to all files with which they are associated regardless of the third party, etc.)
Reports 216, as with dashboards, also will be able to be provided at various levels.

The exemplary system will be able to generate Lender/Agent/Consumer notifications 217 to the respective parties, whether electronically or physically via merge of existing data and transaction proof documents into correspondence. If electronic transmission method is available, electronic notification is sent with proof of the submission (delivery confirmation) ingested in the system with a copy of the correspondence sent. If electronic delivery method is not available or fails, the system will move the electronic submission into a print file. Only after printing of the file will the copy and print confirmation date be uploaded into the system as proof of notification.

As mentioned in the process section of the Suppliers, Inputs, Process, Outputs, Controls (SIPOC) diagram, final products which are contingent on the completion of other processes also will be able to be completed by the system. Title policy letters and email, step 218, are an additional output of the system. The title policy letters may be delivered automatically by email or in hard copy format.

While the system can, in and of itself, be considered a control for the product or service being monitored by the system, there are controls 219 to 222 within the system including escalation triggers for functions which produce no results, and the ability for escalations or manual tollgates for final product (policy) distribution.

Step 219 provides an escalation example by the exemplary system of manual review as an alternate method for items not found. Because of the number of systems that may be an input source to the system, alternate methods for mining the information will be used. As an example, if the requirement is for a release of a document that is of record, the system initially will search for a cross-referenced release document by document ID; if not found, the system will search by party name; if not found, the system will search by truncated party name; if not found, the system will search by legal description; if not found, the system will search by address; and so on until all search methods of searching the source data have been exhausted, after which the file, or service is escalated to a work queue so a manual search may be conducted. The system will start a recording the steps of the manual search, and if the manual search is successful, the recording of the method is sent to the system and incorporated as the next tier of automated search. Items in the escalation queue are re-attempted automatically upon any additional search methods discovered.

If manual review is still unsuccessful, a second manual review, step 220, may be conducted as a redundancy.

By providing reporting 221 of all steps within the process to all providers, the system is expected to act as a control and of each service provider or provide proof of completion of the contribution to the overall process.

This transparency of upstream and downstream processes, step 222, is expected to allow further precision in root cause identification as described in the factors section of the scorecard (see FIG. 9), and promote effective decision making and process improvement throughout the chain (see FIG. 10).

Due to the regulatory timeframes within which the process is allowed to function, and the substantial effort required for the continued monitoring of pending items, a loop limiter is required to stabilize the associated cost of product management. In the current processes, monitoring either continues indefinitely, or litigation is required to resolve and “force” performance of a service provider. Both of the current options create an adversarial relationship between service providers in the overall process, and further drive up costs. In the financial services use case, escalated complaints that remain unresolved should be forwarded to the CFPB for resolution. This loop limiter 223 will ensure that the responsible parties within the supply chain are represented fairly and correctly and fulfill their obligation to “self-report” (Lenders are required to report process gaps and risks, the disclosed system is also designed to monitor these process gaps and risks. While the initial communications to the non-performer have statutory response times, the enforcement of the response times is left to the regulator who must be notified.) and that parties which are detrimental to the overall delivery also are held accountable.

FIG. 4A shows how the system of suppliers, inputs, process, outputs and controls of the system inter-relate for purposes of achieving the system's outputs. This figure provides a more detailed illustration of the input data, elements 300 to 319, that the system is designed to accommodate and the products of the exemplary disclosed embodiments.

Documentation regarding a new financial transaction, along with public record documents, and their associated meta data, are reflected in elements 300 to 307 of FIG. 4A. These data are entered into the exemplary system 308. The exemplary system converts, as necessary, these data into a format which permits automation of the follow up process. Documentation regarding a new financial transaction may include a purchase contract or lender stipulations 300 for origination of a loan. This information is used by the title agent to perform due diligence efforts 301 and provide a title commitment 303 which details requirements for issuing policy and exceptions from coverage. Settlement or closing disclosures 302 also provide necessary data to determine which requirements have not been paid at closing and should remain on the policy in the form of an exception.

Existing outputs such as the fulfillment documents 305, policy documents 306, and policy data 307 will be monitored, compared and analytics improved upon by the exemplary system. In addition, the system will create new outputs (e.g., elements 309 to 319). Industry scorecard and potential root cause reports not previously available are illustrated in FIG. 4A and include:

1. Post-closing performance measurement and reporting at various levels of the process, including, but not limited to:
a) Title insurance agent
b) Title insurance underwriter
c) Lender
d) Other lien holders
e) Public records registrar

2. QWR/NOE/RFI communications (i.e., Tier 2 communications)

3. Regulator notices/complaints (i.e., Tier 3 communications)

The exemplary disclosed system sends Notices/correspondence 309 to the agent for responsibilities that are not met. The exemplary system also sends notices/correspondence, reflected in steps 310 to 312, to lenders and regulatory entities as well for responsibilities that are not met. Responses from the lender are also tracked, as depicted in step 313. The exemplary system also sends consumer and industry reports and notices, illustrated as 314 to 319, as industry scorecards.

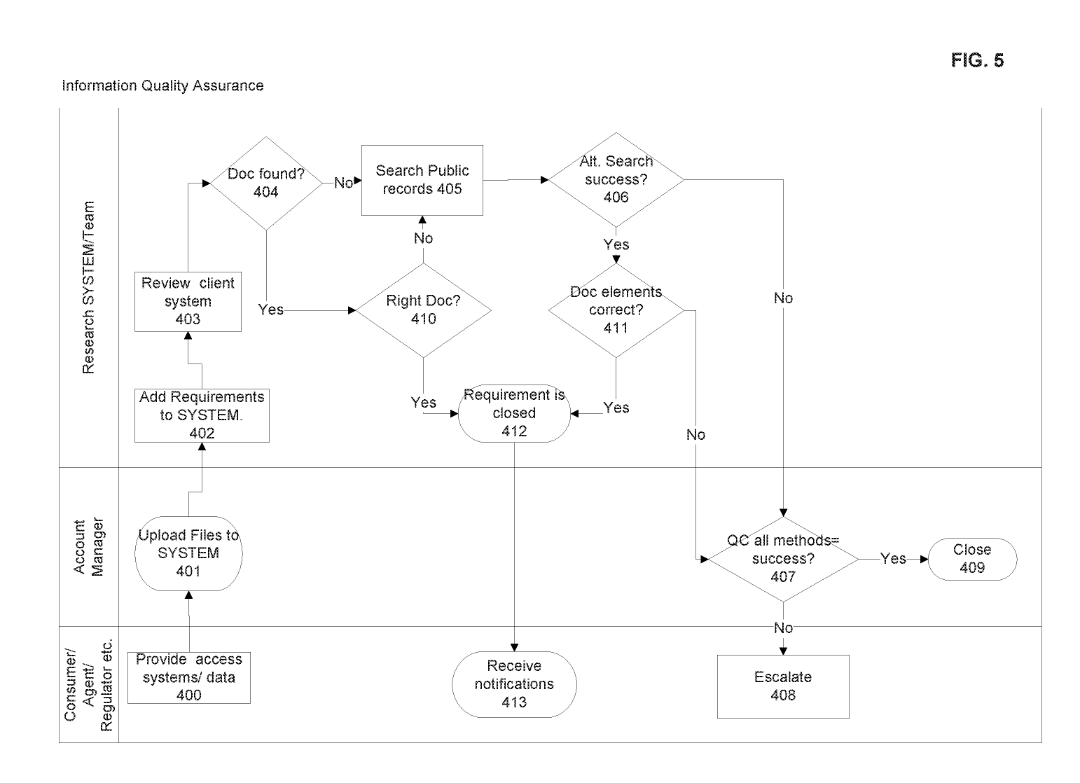

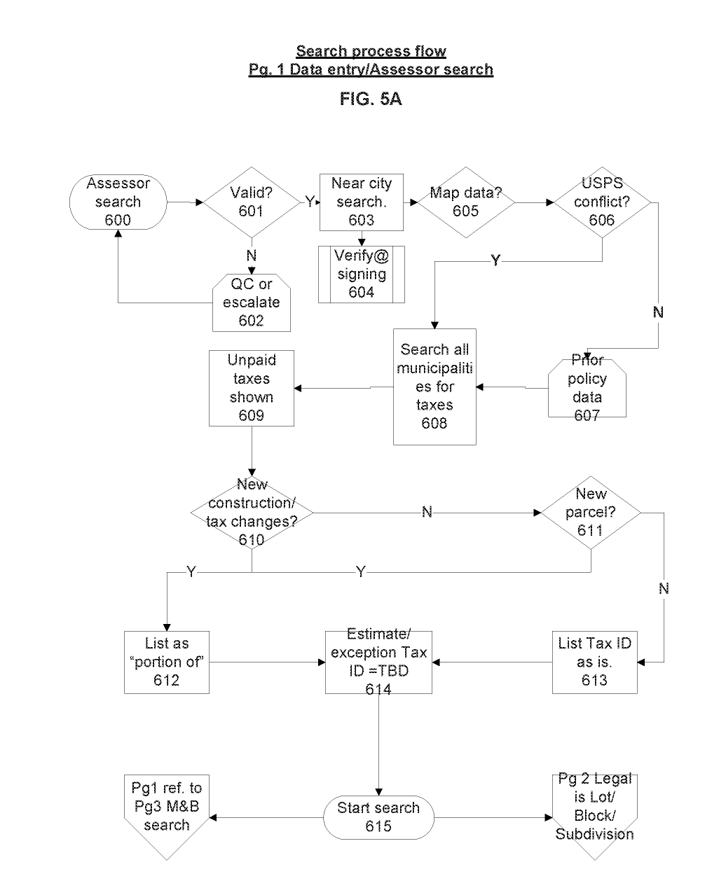

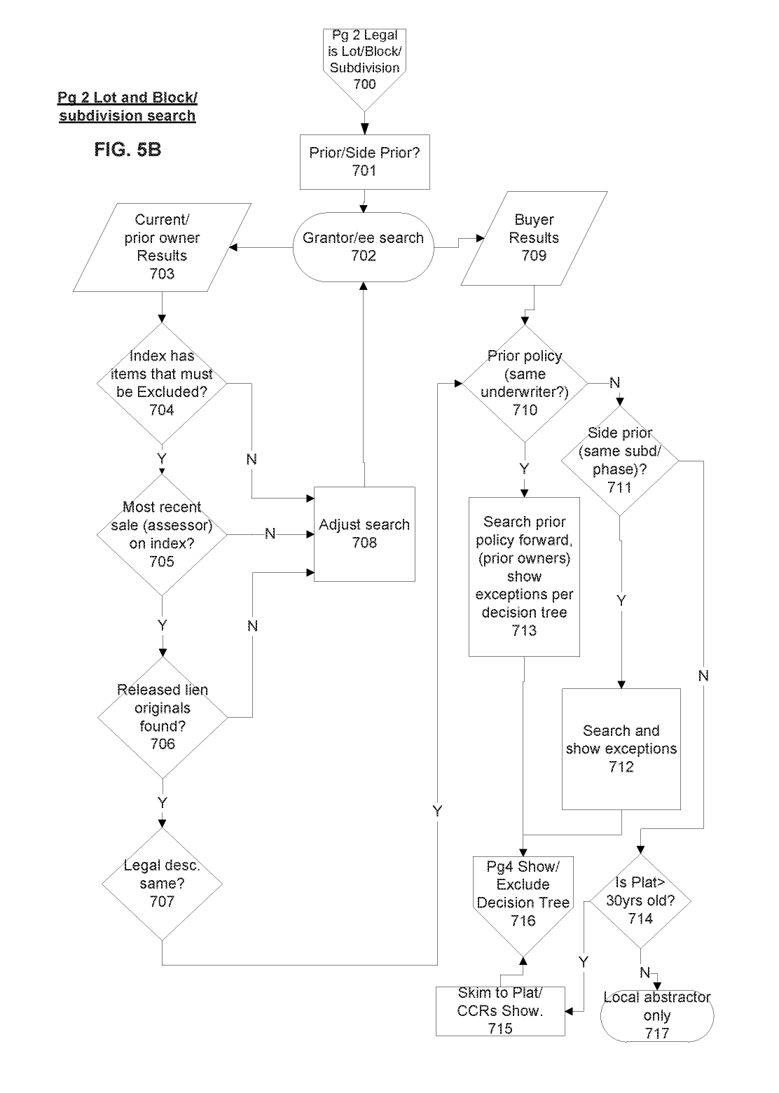

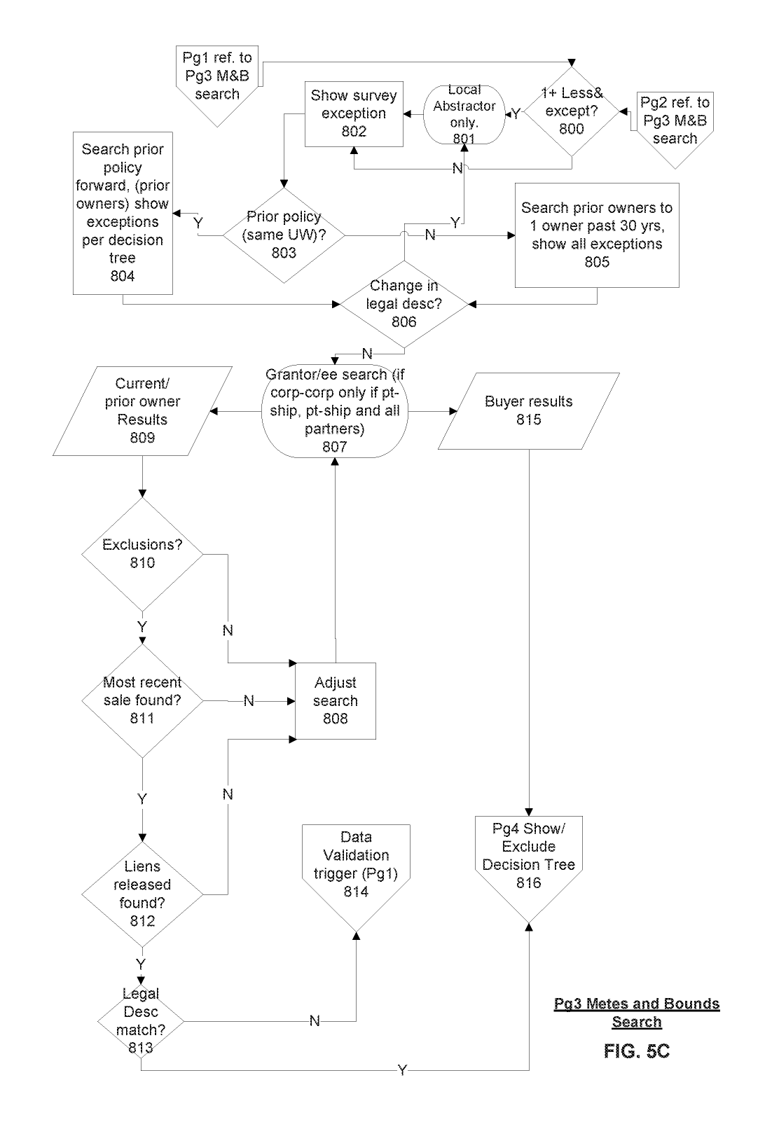

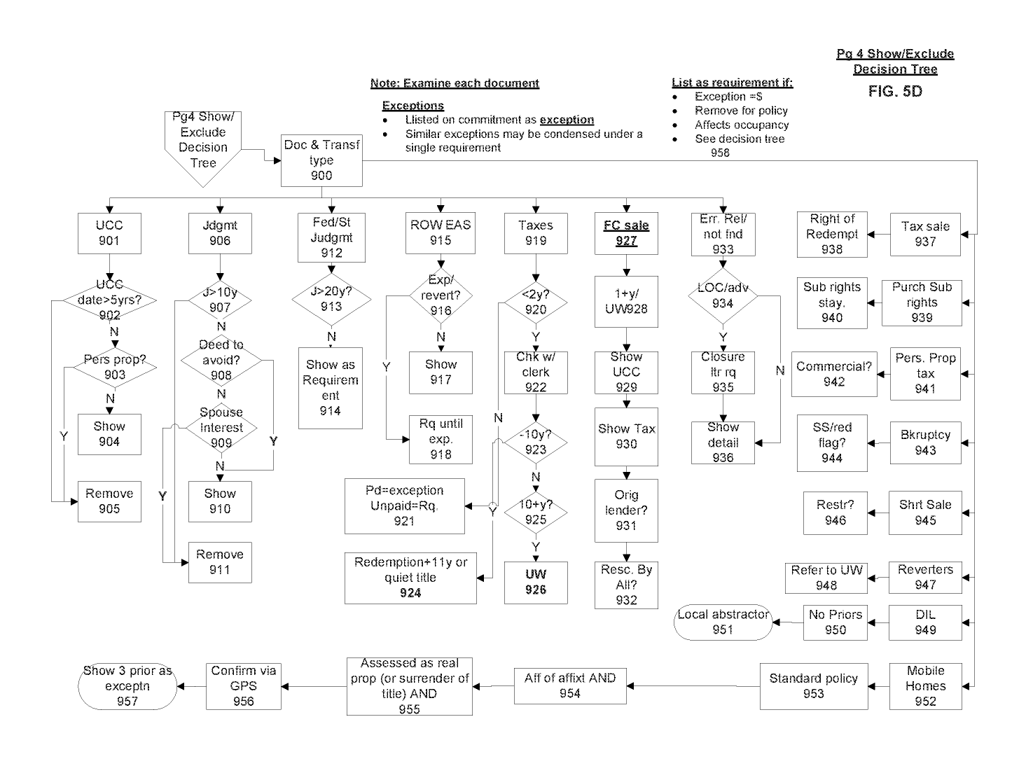

The series of figures, starting with FIG. 5, provide diagrams showing the Information Quality Assurance System of the exemplary disclosed system.

FIG. 5 illustrates a brief workflow of the controls and balances, steps 400 to 413, to ensure accuracy of data being reported and reduction of unwarranted notices/interactions. FIG. 5 is a more detailed workflow showing the redundancies incorporated into the business method to prevent poor data quality. This figure outlines the steps that act as part of the control to ensure that the information entered into the system is trustworthy.

As with any data dependent system, the integrity or quality of the data is paramount. Automated processes will incorporate a redundancy whereby the task completed by automation is performed again, but in a different method when insufficient data elements are returned.

For example, if documents were not found in step 403, an alternate method would be used as shown in step 405, and the information and data is still insufficient, a more broad alternate method would be used as reflected in step 406. If automation is still unsuccessful, then the issue is escalated by the exemplary system for manual validation as shown in step 407.

FIG. 5A provides an illustration of a sub-process for the review of public records data for entering into the disclosed system. This quality assurance process depicted in FIG. 5A shows the typical data entry and assessor search process, which if completed incorrectly by the initial data entry or searcher, may be discovered during the system validation process as an escalation to a manual reviewer. For example, if the parcel number of a transaction was listed on the title commitment incorrectly, the document may be rejected for recordation due to the incorrect parcel number, or if reported may result in an insufficient data validation and escalation to a manual reviewer. It is contemplated that the initial search and data entry by the title agent is primarily correct as it is the bases for data entry into the exemplary system.

FIG. 5B illustrates the search process, particularly lot and block/subdivision search processes, of the exemplary system and is provided to demonstrate the additional fulfillment documents or clearing methods which are available to be incorporated into the system. FIG. 5B also illustrates typical search protocol and the reasons why non-borrowers may be listed under specific requirements which necessitates tracking and follow up by individual requirement.

FIG. 5C is a workflow diagram showing the search process, particularly the metes and bounds search processes of the exemplary system. It demonstrates the agents intrinsic liability for correctly entering complex legal descriptions into the commitment and identifying when a new legal description has been created by including wording such as . . . a portion of . . . prior to the new legal description to allow proper identification of a new parcel or an outparcel.

FIG. 5D illustrates the decision making process behind which items discovered in the title agents search of the public record must be included in the commitment as a requirement or exception, and when they may be disregarded. This process provides controls to prevent “false positives” in the system. The system will be able to accommodate disregarding of prior exemptions and requirements, and reissuance of policy based on statutory limits.

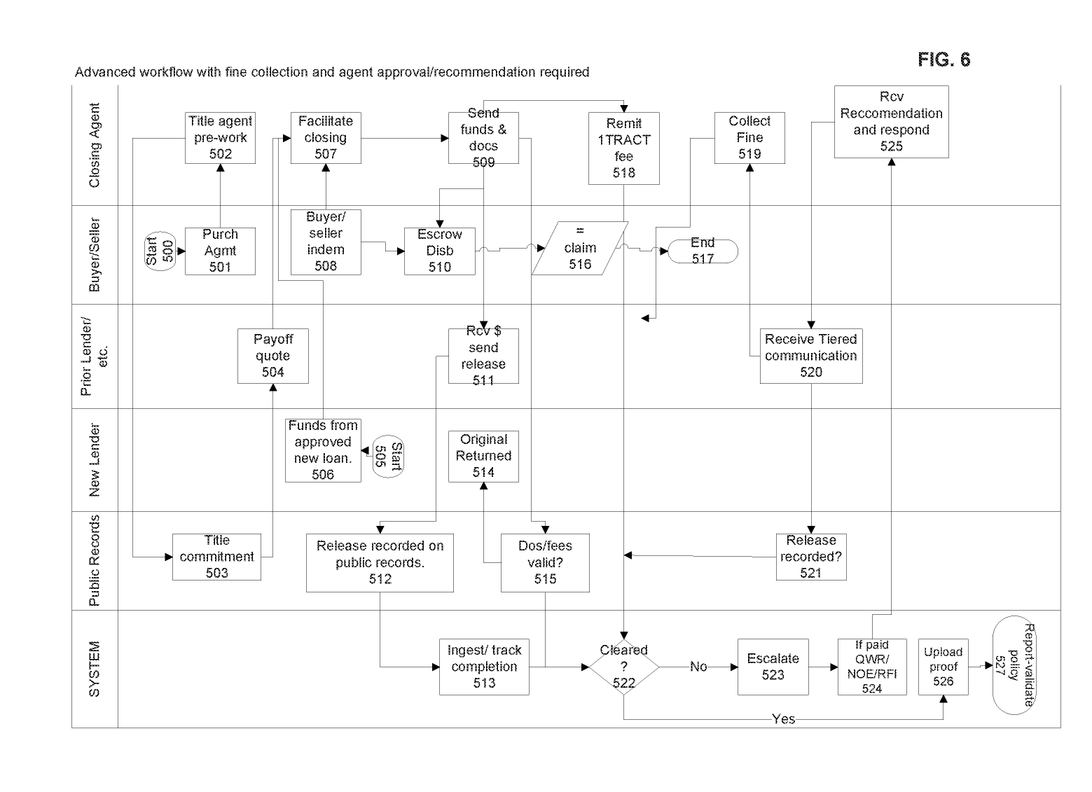

FIG. 6 illustrates the end to end workflow for an advanced implementation variation by a title agent that wishes to pursue treble damages or regulatory fines against non-compliant parties. The system interaction would track collection of fees and fines for such non-compliance and produce an alert or recommendation for when fines may be available to pursue while still performing the core function of timely communication with all parties, continued follow up and policy issuance.

The series of steps from 600 to 900 shows a finely detailed listing of controls to ensure that the original requirement data being entered is reliable.

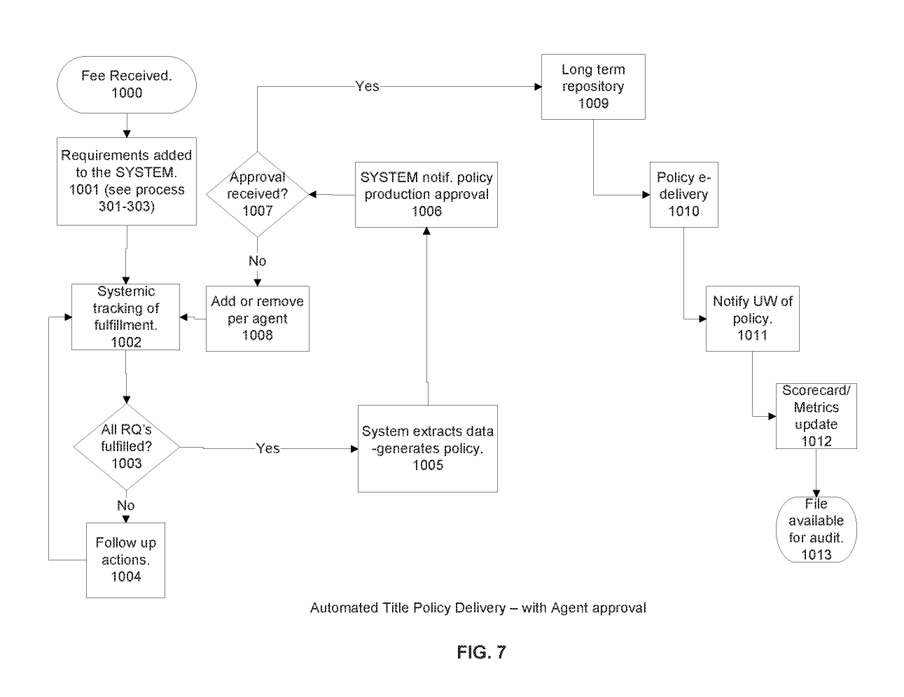

FIG. 7 illustrates another implementation variation by a user that does not want to pursue treble damages, but prefers to give final approval of all insurance policies presented to the consumer or lender, once all title requirements have been satisfied, the system sends an electronic communication from the system, to the agent confirming completion, and waits to provide notice to the consumer or lender until approved by the agent.

Through steps 1000 through 1007 in FIG. 7, the exemplary system will monitor for fulfillment of requirements as previously described in 220, which upon completion, the system will create the policy (extracting info from file's title commitment letter) and submit a communication to the agent for final approval.

As shown in step 1008, if the agent does not approve, additional requirements will be added, or existing requirements will be amended and the tracking and escalation protocol described in the 200 series will begin anew.

In step 1009, the exemplary system routes the final title insurance policy to a cloud-based long term document repository. The repository then delivers the final title insurance policy, as reviewed and approved by the title agent, automatically to the insured property purchaser, title insurance agent, title insurance underwriter and lender-mortgagee through steps 1010 and 1011.

In steps 1012 and 1013, the exemplary system then measures the length of time between the closing date and the date when final title policy is delivered to the insured. All documentation evidencing the completion of obligations related to the transaction are retained in long-term storage in the event of future audits.

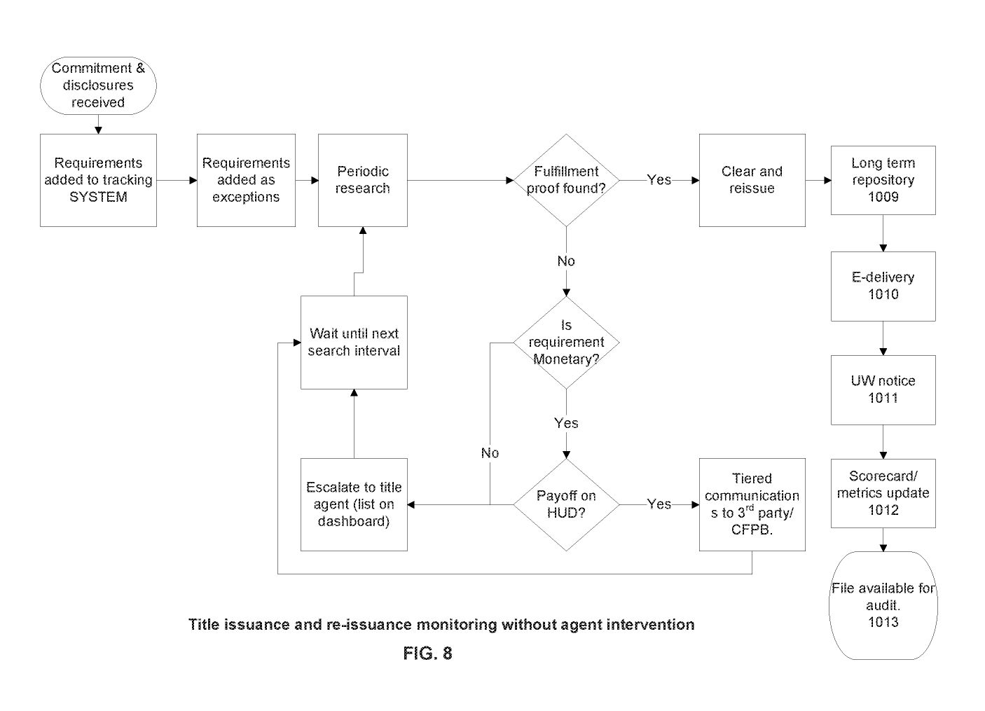

FIG. 8 illustrates an advanced implantation variation by a title agent that does not require final review and approval prior to providing to the consumer and or lender.

What is claimed is:

1. A method for controlling an electronic title insurance registry configured to facilitate the delivery of a title insurance policy, the method comprising the steps of:
accessing data from a first database, wherein the data comprises real estate transaction information;
comparing said data against a performance metric, wherein the performance metric provides a gauge for ascertaining whether the data fulfills a real estate transaction requirement;
calculating a score of the comparison of said data against said performance metric, wherein the score indicates compliance of a real estate transaction with a regulatory real estate title requirement;
reporting said score;
preparing a title insurance policy based on said score; and
delivering said title insurance policy based on said score.

2. The method of claim 1, wherein the real estate transaction information comprises at least one of title insurance information and title requirements necessary for the fulfillment, effectiveness, and delivery of title insurance policies to purchasers of real property and proof of satisfaction thereof.

3. The method of claim 1, wherein the performance metric comprises at least one of timeliness, accuracy, performance of tasks necessary for the fulfillment, effectiveness, and delivery of title insurance policies, and variance over time of the performance metric.

4. The method of claim 1, further comprising communicating at least one of a qualified written request, notice of error, and request for information from a borrower.

5. The method of claim 1, further comprising preparing a scorecard, wherein the scorecard includes at least one of the real estate transaction information, performance metric, and score for at least a first service provider involved in the delivery of a title insurance policy.

6. The method of claim 5, wherein the score for the first service provider is a weighted score based on at least one of whether the first service provider has sole, primary, contributing, or facilitating responsibility for fulfillment of tasks related to the score, geographic location of the first service provider, and resources available to the first service provider for fulfillment of tasks related to the score.

7. The method of claim 6, further comprising determining a best practice for a fulfillment of tasks based on practices of peer services providers in the same geographic location as the first service provider, wherein the score for the first service provider is further weighted based on whether the first service provider has adopted the best practice of the peer service providers.

8. The method of claim 1, further comprising displaying at least one of the real estate transaction information, performance metric, score, and title insurance policy on a dashboard on an electronic display device.

9. A system for controlling an electronic title insurance registry configured to facilitate the delivery of a title insurance policy, the system comprising:
a computer network configured to access real estate transaction information, compare said real estate transaction information against a performance metric which provides a gauge for ascertaining whether said real estate transaction information fulfills a real estate transaction requirement, calculate a compliance score of a real estate transaction with a regulatory real estate title requirement based at least in part on said comparison, report said score to a first service provider involved in the delivery of a title insurance policy, prepare a title insurance policy based on said score, and deliver said title insurance policy to at least one of the first service provider and a second service provider based on said score.

10. The system of claim 9, wherein the computer network comprises at least one computer processor and associated software, and the computer network is configured based at least in part on the function of the computer processor and associated software.

11. The system of claim 9, further comprising a data storage device configured to store the real estate transaction information and associated documents.

12. The system of claim 9, further comprising an electronic display configured to display a dashboard including at least one of the real estate transaction information, performance metric, score, and title insurance policy.

13. A non-transitory computer readable medium configured to carry out a method for controlling an electronic title insurance registry and facilitating the delivery of a title insurance policy when executed, the method comprising:
accessing real estate transaction information from a data storage device;
comparing said real estate transaction information against a performance metric for ascertaining whether the real estate transaction information fulfills a real estate transaction requirement;
calculating a compliance score of a real estate transaction with a regulatory real estate title requirement based at least in part on said comparison;
reporting said score;
preparing a title insurance policy based on said score; and
delivering said title insurance policy based on said score.

14. The non-transitory computer readable medium of claim 13, wherein the real estate transaction information comprises at least one of title insurance information and title requirements necessary for the fulfillment, effectiveness, and delivery of title insurance policies to purchasers of real property and proof of satisfaction thereof.

15. The non-transitory computer readable medium of claim 13, wherein the performance metric comprises at least one of timeliness, accuracy, performance of tasks necessary for the fulfillment, effectiveness, and delivery of title insurance policies, and variance over time of the performance metric.

16. The non-transitory computer readable medium of claim 13, wherein the method further comprises communicating at least one of a qualified written request, notice of error, and request for information from a borrower.

17. The non-transitory computer readable medium of claim 13, wherein the method further comprises preparing a scorecard and the scorecard includes at least one of the real estate transaction information, performance metric, and score for at least a first service provider involved in the delivery of a title insurance policy.

18. The non-transitory computer readable medium of claim 17, wherein the score for the first service provider is a weighted score based on at least one of whether the first service provider has sole, primary, contributing, or facilitating responsibility for fulfillment of tasks related to the score, geographic location of the first service provider, and resources available to the first service provider for fulfillment of tasks related to the score.

19. The non-transitory computer readable medium of claim 18, wherein the method further comprises determining at least one best practice for a fulfillment of tasks based on practices of peer service providers in the same geographic location as the first service provider, wherein the score for the first service provider is further weighted based on whether the first service provider has adopted the best practice established by the peer service providers.

20. The non-transitory computer readable medium of claim 13, wherein the method further comprises displaying at least one of the real estate transaction information, performance metric, score, and title insurance policy on a dashboard on an electronic display device.
